SEQUENCE LISTING (14 sequences)

SEQ ID NO: 1 - DNA, 45 bp, artificial sequence
  synthetic - representing portion of H. sapiens beta-actin
ttttgtccccccaacttgatgtatgaaggctttggtctccctggg

SEQ ID NO: 2 - DNA, 45 bp, artificial sequence
  synthetic - representing a portion of H. sapiens NF-L
ggccgttctgcttacagtggcttgcagagcagctcctacttgatg

SEQ ID NO: 3 - DNA, 45 bp, artificial sequence
  synthetic - representing a portion of H. sapiens Ubiquitin 2e
gtaccaacattgcctcctagcagagaagtgtgtgtgtgagaagcc

SEQ ID NO: 4 - DNA, 45 bp, artificial sequence
  synthetic - representing a portion of H. sapiens hsc70
cctatggtgcagctgtccaggcagccattctatctggagacaagt

SEQ ID NO: 5 - DNA, 45 bp, artificial sequence
  synthetic - representing a portion of H. sapiens rpL3
ggtgaggtgaccaatgacttcatcatgctcaaaggctgtgtggtg

SEQ ID NO: 6 - DNA, 45 bp, artificial sequence
  synthetic - representing a portion of H. sapiens Akt
gctggacaaggacgggcacatcaagataacggacttcgggctgtg

SEQ ID NO: 7 - DNA, 45 bp, artificial sequence
  synthetic - representing a portion of H. sapiens Transthyretin
accatcgcagccctgctcagcccatactcctacagcaccacggct

SEQ ID NO: 8 - DNA, 45 bp, artificial sequence
  synthetic - representing a portion of H. sapiens rpS5
cattgctgtgaaggagaagtatgccaagtacctgccccacagtgc

SEQ ID NO: 9 - DNA, 45 bp, artificial sequence
  syntehtic - representing a portion of H. sapiens HCN1
gtgccacagcgtgtcaccttgttcagacagatgtcctcgggagcc

SEQ ID NO: 10 - DNA, 45 bp, artificial sequence
  synthetic - representing a portion of H. sapiens GAPDH
gcagtggcaaagtggagattgttgccatcaacgaccccttcattg

SEQ ID NO: 11 - DNA, 45 bp, artificial sequence
  synthetic - representing a portion of H. sapiens Lhb1B2
actcaagttatcctcatgggagctgttgaaggctacagagtcgcc

SEQ ID NO: 12 - DNA, 20 bp, Homo Sapiens
  ABO blood group protein (ABO) gene
ggacatggagttccgcgacc

SEQ ID NO: 13 - DNA, 20 bp, Homo sapiens
  ABO blood group protein (ABO) gene
ggacatggagatccgcgacc

SEQ ID NO: 14 - DNA, 20 bp, Homo sapiens
  ABO blood group protein (ABO) gene
ggtcgcggaactccatgtcc

(19) United States
(12) Patent Application Publication
(10) Pub. No.: US 2010/0256004 A1
(43) Pub. Date: Oct. 7, 2010

(54) Device of Testing Interaction Between Biomolecules, Method of Testing Interaction Between Biomolecules,Method of Measuring Melting Temperature of Biomolecule,Method of Sequencing Nucleic Acid,Method of Causing Interaction Between Biomolecules,and Method of Causing Migration of Biomolecule

(75) Inventors: Hideo Tashiro, Wako-shi (JP); Yasumitsu Kondoh, Wako-shi (JP); Tikara Koike, Wako-shi (JP); Takayuki Shimamura, Wako-shi (JP)

Correspondence Address: BIRCH STEWART KOLASCH & BIRCH, PO BOX 747, FALLS CHURCH, VA, 22040-0747, US

(73) Assignee: RIKEN, Wako-shi, SAITAMA (JP)

(21) Appl. No.: 11/791,072

(22) PCT Filed: Nov. 4, 2005
(86) PCT No.: PCT/JP2005/020295

§ 371 Date: Nov. 19, 2007

(30) Foreign Application Priority Data
Nov. 18, 2004 (JP) 2004-334302
Nov. 19, 2004 (JP) 2004-336333

(51) Int. Cl. C40B 30/04; C40B 40/00; C40B 40/04; C40B 40/08; C40B 40/06; C40B 40/10; C40B 40/12; G01N 27/26

(52) U.S. Cl. 506/9; 506/13; 506/15; 506/17; 506/16; 506/18; 506/19; 205/792

(57) ABSTRACT

The device of testing interaction between biomolecules comprising a biomolecule microarray in which a biomolecule is immobilized on a substrate and a transparent electrode (opposite electrode) positioned so as to face the surface of the substrate of the microarray on which the bimolecule is immobilized. The device comprises a nonconductive spacer between the microarray and the opposite electrode, and a cavity is formed by the microarray, spacer and opposite electrode, and the microarray comprises a conductive material surface on at least a portion of the surface on which the biomolecule is immobilized, as well as comprises two through-holes communicating with the cavity, one of which is a hole for introducing a solution into the cavity, and the other of which is a hole for discharging a solution from the cavity. The method in which a solution comprising a target biomolecule is placed between a biomolecule microarray comprising one or more spots in which a biomolecule is immobilized on a substrate surface and an opposite electrode to cause interaction between the biomolecule immobilized on the substrate surface and the target biomolecule. The microarray comprises a conductive material surface on at least a portion of the surface on which the biomolecule is immobilized, and a voltage at a frequency ranging from 0.01 to 10 Hz is applied between the conductive material surface and the opposite electrode to promote the interaction. the method of causing migration of a biomolecule comprised in a solution placed between a substrate on at least a portion of which a conductive material surface is comprised and an opposite electrode. A voltage at a frequency ranging from 0.01 to 10 Hz is applied between the conductive material surface and the opposite electrode to cause the biomolecule to migrate toward either the substrate or the opposite electrode.

### TECHNICAL FIELD

The present invention relates to a device capable of conveniently and rapidly testing interaction between a target biomolecule and a probe biomolecule, and to a method of testing the interaction. The present invention further relates to a method of measuring a melting temperature of a biomolecule and to a method of sequencing a nucleic acid, both employing the aforementioned method.

Still further, the present invention relates to a method of causing interaction between a biomolecule immobilized on a substrate and a biomolecule contained in a solution, and to a method of causing biomolecules contained in a solution to unidirectionally and selectively migrate.

### TECHNICAL BACKGROUND

For the purpose of the detection of specific nucleic acids (target nucleic acids), such as genetic diagnosis, identification of pathogenic bacteria, and the detection of single nucleotide polymorphisms, the hybridization between probe nucleic acid and target nucleic acid is employed. In recent years, DNA chips and DNA microarrays in which multiple probe nucleic acids are immobilized on a substrate have been put to practical use to detect target nucleic acids.

In the manufacturing of DNA chips and DNA microarrays, DNA must be arrayed in a form of multiple spots and immobilized on a substrate. For example, the method of immobilizing single-stranded DNA that has been terminally thiol-modified on a gold substrate, for example, has been adopted to immobilize the DNA. The immobilized DNA is then subjected to the action of target DNA in the form of the specimen, and the presence or absence of hybridization is detected. The presence or absence of hybridization can be detected by measuring the fluorescence of immobilized DNA spots that have hybridized with fluorescence-labeled target DNA.

To cause probe DNA that has been immobilized on a substrate to hybridize with sample target DNA, for example, a method is employed in which a hybridization solution containing target DNA is dripped onto a DNA microarray on which probe DNA is immobilized, a glass cover is applied to prevent the solution from drying out, the assembly is placed in a moist, tightly sealed case, and a hybrid-forming reaction is conducted at a temperature suited to the target DNA and probe DNA (Japanese Unexamined Patent Publication (KOKAI) No. 2003-156442) (referred to as “Reference Document 1”, hereinafter). However, in such methods, hybrid formation was not observed in real time.

By contrast, published Japanese translation of PCT international publication for patent application (KOHYO) No. Heisei 10-505410 (referred to as “Reference Document 2”, hereinafter) discloses a bioarray chip reaction device in which an array on which DNA is immobilized is sealed within a chamber. This device has a configuration permitting the introduction of the solution into the chamber. Reference Document 2 describes that the substrate or cover of the device may be transparent. Based on a device such as that described in Reference Document 2, the formation of hybrids should conceivably be observable in real time through the transparent substrate or through the cover while introducing solution into the chamber.

However, a period of ten and some odd hours is normally required to cause the hybridization of probe DNA and target DNA, and a large quantity of sample target DNA is required. Thus, in the device described in Reference Document 2, although it may be possible to observe the formation of hybrids in real time, an extended period is required. Thus, rapid observation is difficult. Further, a large quantity of sample must be prepared to cause probe DNA and target DNA to hybridize.

Further, a period of ten and some odd hours is normally required to cause the hybridization of probe DNA and target DNA, and a large quantity of sample target DNA is required. Thus, in the device described in Reference Document 1, since an extended period is required to form hybrids, rapid observation is difficult. Further, a large quantity of sample must be prepared to cause probe DNA and target DNA to hybridize.

### DISCLOSURE OF THE INVENTION

### Problems to be Solved by the Invention

The first object of the present invention is to provide a means for permitting rapid formation of interaction between biomolecules without requiring a large quantity of sample or considerable time and effort, and for permitting the detection in real time of interactions between biomolecules.

The second object of the present invention is to provide a means for promoting interaction between biomolecules in a microarray to permit a rapid and highly sensitive reaction.

### Means for Solving Problems

The first aspect of the present invention for achieving the above first object is as follows:

[1] A device of testing interaction between biomolecules comprising a biomolecule microarray (1) in which a biomolecule is immobilized on a substrate and a transparent electrode (2) positioned so as to face the surface of the substrate of said microarray on which the biomolecule is immobilized, which electrode is hereinafter referred to as “opposite electrode”, wherein
said device comprises a nonconductive spacer between said microarray (1) and said opposite electrode (2), and a cavity (4) is formed by said microarray (1), said spacer (3) and said opposite electrode (2),
said microarray (1) comprises a conductive material surface (6) on at least a portion of the surface on which the biomolecule is immobilized, as well as comprises two through-holes (5) communicating with said cavity (4), one of which is a hole for introducing a solution into the cavity, and the other of which is a hole for discharging a solution from the cavity.
   [2] The device according to [1], which comprises a means for connecting the conductive material surface (6) on said microarray (1) and the opposite electrode (2) to an external power source from the side of said microarray (1).
   [3] The device according to [2], which further comprises a conductive stuff (7) at least a portion of which contacts the conductive material surface (6) of said microarray (1) and does not contact said opposite electrode (2), and the conductive material surface (6) on said substrate is connected through said conductive stuff (7) to the external power source.
   [4] The device according to [3], wherein the conductive material included in said conductive stuff (7) is gold, nickel, platinum, silver, titanium, aluminum, stainless steel, copper, conductive oxide, or conductive plastic.
   [5] The device according to [3] or [4], wherein said microarray comprises a through-hole (8) communicating with said conductive stuff (7) and a through-hole (9) communicating with said opposite electrode (2).
   [6] The device according to any of [1] to [5], wherein said nonconductive spacer (3) is positioned so as to make an interval between said microarray (1) and said opposite electrode (2) uniform.
   [7] The device according to any of [1] to [6], wherein the distance between the surface of said microarray (1) on which the biomolecule is immobilized and the surface of said opposite electrode (2) which faces the surface of said microarray (1) on which the biomolecule is immobilized ranges from 10 to 30 micrometers.
   [8] The device according to any of [1] to [7], wherein the conductive material included in the conductive material surface on said microarray is gold, nickel, platinum, silver, titanium, aluminum, stainless steel, copper, chromium, conductive oxide, or conductive plastic.
   [9] The device according to any of [1] to [8], wherein the whole of said substrate consists of a conductive material or said substrate comprises a conductive material coating layer on the surface of the substrate.
   [10] The device according to [9], wherein said substrate comprising a conductive material coating layer consists of glass, quartz, metal, silicon, or plastic.
   [11] The device according to any of [1] to [10], wherein said nonconductive spacer (3) comprises adhesive layers on both surfaces thereof.
   [12] The device according to [11], wherein said adhesive comprises a photosetting resin.
   [13] The device according to any of [1] to [12], which further comprises a temperature control means.
   [14] The device according to any of [1] to [13], wherein

said substrate comprises a spot for immobilizing a biomolecule which protrudes from the surface of the substrate and comprises a flat surface for spotting on the top thereof, which spot is hereinafter referred to as “protruding spot part”,

at least said protruding spot part comprises a conductive material surface,

a biomolecule is immobilized on the conductive material surface of said flat surface for spotting, and

said substrate comprises a terminal capable of passing an electric current to said conductive material surface of the protruding spot part on the surface of said substrate in areas other than the protruding spot part.

[15] The device according to [14], wherein said surface of the substrate in areas other than the protruding spot part comprises a conductive material coating layer, said terminal is comprised in said conductive material coating layer or capable of passing an electric current to said conductive material coating layer.
[16] The device according to [14] or [15], wherein said surface of the substrate in areas other than the protruding spot part comprises a conductive material coating layer, and said conductive material coating layer and the conductive material surface of the protruding spot part are provided as an integrated conductive material coating layer.
[17] The device according to any of [14] to [16], wherein said substrate is a substrate in which at least the substrate surface around the protruding spot part, the lateral surface of the protruding spot part, and the flat surface for spotting are comprised of a conductive material.
[18] The device according to [17], wherein said substrate surface around the protruding spot part forms a roughly V-shaped bottom surface.
[19] The device according to any of [14] to [16], wherein said substrate is a substrate in which the protruding spot parts adjacent each other border through the lateral surface of the protruding spot part, and at least said lateral surface of the protruding spot part and the flat surface for spotting are comprised of a conductive material.
[20] The device according to any of [14] to [19], wherein said protruding spot part has a height ranging from 10 to 500 micrometers.
[21] The device according to any of [14] to [20], wherein the angle formed between said flat surface for spotting on the top of the protruding spot part and said lateral surface of the protruding spot part is equal to or greater than 90 degrees.
[22] The device according to any of [14] to [21], wherein said spot for immobilizing a biomolecule is a roughened surface.
[23] The device according to any of [1] to [22], wherein said biomolecule is at least one selected from the group consisting of DNA, RNA, PNA, protein, polypeptide, sugar compound, lipid, natural small molecule, and synthetic small molecule.
[24] A method of testing interaction between biomolecules using a device comprising a biomolecule microarray (1) in which a biomolecule is immobilized on a substrate and a transparent electrode (2) positioned so as to face the surface of said microarray on which the biomolecule is immobilized, which electrode is hereinafter referred to as “opposite electrode”, as well as comprising a nonconductive spacer between said microarray (1) and said opposite electrode (2) in which a cavity (4) is formed by said microarray (1), said spacer (3) and said opposite electrode (2), wherein

said microarray (1) comprises a conductive material surface (6) on at least a portion of the surface on which the biomolecule is immobilized, as well as

said method comprises:

applying an electric field between said microarray (1) and said opposite electrode (2),

while introducing a solution comprising a target biomolecule and/or a solution not comprising a target biomolecule into said cavity (4), optically detecting through said opposite electrode interaction between said biomolecule on the microarray and said target biomolecule.

[25] A method of testing interaction between biomolecules using a device comprising a biomolecule microarray (1) in which a biomolecule is immobilized on a substrate and a transparent electrode (2) positioned so as to face the surface of said microarray on which the biomolecule is immobilized, which electrode is hereinafter referred to as “opposite electrode”, as well as comprising a nonconductive spacer between said microarray (1) and said opposite electrode (2) in which a cavity (4) is formed by said microarray (1), said spacer (3) and said opposite electrode (2), wherein

said microarray (1) comprises a conductive material surface (6) on at least a portion of the surface on which the biomolecule is immobilized, as well as

said method comprises:

applying an electric field between said microarray (1) and said opposite electrode (2),

filling said cavity (4) with a solution comprising a target biomolecule, maintaining the solution in the cavity for a prescribed period, and then discharging said solution, and

optically detecting through said opposite electrode interaction between said biomolecule on the microarray and said target biomolecule while said solution is being maintained or after said solution has been discharged.

[26] The method according to [25], which comprises newly filling said cavity with a solution comprising a target biomolecule and/or a solution not comprising a target biomolecule after said solution has been discharged or while said solution is being discharged.
[27] The method according to any of [24] to [26], wherein the conductive material surface (6) on said microarray (1) and the opposite electrode (2) are connected to an external power source from the side of said microarray (1) to apply an electric field between said microarray (1) and said opposite electrode (2).
[28] The method according to any of [24] to [27], wherein said device is the device according to any of [1] to [23].
[29] The method according to [28], wherein the solution is introduced into said cavity and/or the solution is discharged from said cavity through the through-hole (5) comprised in said microarray (1) and communicating with said cavity.
[30] The method according to any of [24] to [27], wherein said device is the device according to any of [5] to [23], and said conductive stuff (7) and said opposite electrode (2) are connected to a terminal of the external power source through the through-hole (8) communicating with said conductive stuff (7) and the through-hole (9) communicating with said opposite electrode (2).
[31] The method according to [31], wherein the solution is introduced into said cavity and/or the solution is discharged from said cavity through the through-hole (5) comprised in said microarray (1) and communicating with said cavity.
[32] The method according to any of [24] to [31], wherein said biomolecule immobilized on the microarray and/or said target biomolecule are labeled with a fluorochrome, and the interaction between said biomolecule on the microarray and said target biomolecule are detected by fluorescence.
[33] A method of testing interaction between biomolecules using the device according to any of [14] to [23], comprising:

applying an electric field between said microarray (1) and said opposite electrode (2), and

while introducing a solution comprising a target biomolecule and/or a solution not comprising a target biomolecule into said cavity (4), detecting through said opposite electrode interaction between said biomolecule on the microarray and said target biomolecule with a confocal detector.

[34] A method of testing interaction between biomolecules using the device according to any of [14] to [23], comprising:

applying an electric field between said microarray (1) and said opposite electrode (2),

filling said cavity (4) with a solution comprising a target biomolecule, maintaining the solution in the cavity for a prescribed period, and then discharging said solution, and

detecting through said opposite electrode interaction between said biomolecule on the microarray and said target biomolecule with a confocal detector while said solution is being maintained or after said solution has been discharged.

[35] The method according to [34], which comprises newly filling said cavity with a solution comprising a target biomolecule and/or a solution not comprising a target biomolecule after said solution has been discharged or while said solution is being discharged.
[36] The method according to any of [33] to [35], wherein said biomolecule on the microarray and/or said target biomolecule are labeled with a fluorochrome.
[37] The method according to any of [33] to [36], wherein, with said confocal detector, said protruding spot part on the microarray is detected as a reflected image from the difference in intensity of reflected light based on differences in the height and/or shape of the protruding spot part and other portions on the surface of the microarray.
[38] The method according to [37], wherein the interaction between biomolecules is detected by detecting fluorescence from said protruding spot part detected as a reflected image.
[39] The method according to any of [33] to [38], wherein the solution is introduced into said cavity and/or the solution is discharged from said cavity through the through-hole (5) comprised in said microarray (1) and communicating with said cavity.
[40] The method according to any of [33] to [39], wherein said conductive stuff (7) and said opposite electrode (2) are connected to a terminal of the external power source through the through-hole (8) communicating with said conductive stuff (7) and the through-hole (9) communicating with said opposite electrode (2).
[41] The method according to any of [24] to [40], wherein the electric field applied between said microarray (1) and said opposite electrode (2) ranges from 0.01 to 10 MV/m.
[42] The method according to any of [24] to [41], wherein said solution comprising the target biomolecule comprises at least one buffer substance selected from the group consisting of phenylalanine, histidine, carnosine and arginine.
[43] A method of measuring a melting temperature of a biomolecule, characterized by using the method according to any of [24] to [42].
[44] A method of sequencing a nucleic acid, characterized by using the method according to any of [24] to [42].

The second aspect of the present invention for achieving the above second object is as follows:

[45] A method in which a solution comprising a target biomolecule is placed between a biomolecule microarray comprising one or more spots in which a biomolecule is immobilized on a substrate surface and an electrode facing said substrate surface, which electrode is hereinafter referred to as “opposite electrode”, to cause interaction between said biomolecule immobilized on the substrate surface and said target biomolecule, characterized in that

said microarray comprises a conductive material surface on at least a portion of the surface on which the biomolecule is immobilized, and

a voltage at a frequency ranging from 0.01 to 10 Hz is applied between said conductive material surface and said opposite electrode to promote said interaction.

[46] A method of causing migration of a biomolecule comprised in a solution placed between a substrate on at least a portion of which a conductive material surface is comprised and an electrode facing said conductive material surface, which electrode is hereinafter referred to as “opposite electrode”, characterized by applying a voltage at a frequency ranging from 0.01 to 10 Hz between said conductive material surface and said opposite electrode to cause said biomolecule to migrate toward either said substrate or said opposite electrode.
[47] The method according to [45] or [46], wherein said voltage ranges from 0.1 to 4 V.
[48] The method according to any of [45] to [47], wherein said solution comprises a cation.
[49] The method according to [48], wherein said cation is at least one selected from the group consisting of sodium ion, potassium ion, lithium ion, magnesium ion, calcium ion, and aluminum ion.
[50] The method according to [48] or [49], wherein the concentration of cation in said solution ranges from 1 to 1000 mM.
[51] The method according to any of [45] to [50], wherein said voltage is a pulsed direct current voltage.
[52] The method according to any of [45] to [50], further comprising applying the voltage in such a manner that said substrate surface is negatively charged.
[53] The method according to any of [45] to [53], wherein the whole of said substrate consists of a conductive material or said substrate comprises a conductive material coating layer on the substrate surface.
[54] The method according to any of [45] to [53], wherein said conductive material is gold, nickel, platinum, silver, titanium, aluminum, stainless steel, copper, chromium, conductive oxide, or conductive plastic.
[55] The method according to any of [45] to [54], wherein the whole of said opposite electrode consists of gold, nickel, platinum, silver, titanium, aluminum, stainless steel, copper, chromium, conductive oxide, or conductive plastic, or said opposite electrode comprises a conductive material coating layer consisting of gold, nickel, platinum, silver, titanium, aluminum, stainless steel, copper, chromium, conductive oxide, or conductive plastic on the surface thereof facing said conductive material surface of the substrate.
[56] The method according to any of [45] to [55], wherein said opposite electrode is a transparent electrode.
[57] The method according to any of [45] to [56], wherein a nonconductive spacer is positioned between said substrate and said opposite electrode, and a space enclosed by said substrate, opposite electrode and nonconductive spacer is filled with said solution.
[58] The method according to [57], comprising stirring said solution during the period when no voltage is being applied between said conductive material surface and said opposite electrode.
[59] The method according to any of [45] to [58], wherein said biomolecule is at least one selected from the group consisting of DNA, RNA, PNA, protein, polypeptide, sugar compound, lipid, natural small molecule, and synthetic small molecule.

### EFFECTS OF THE INVENTION

According to the first aspect of the present invention, interaction between biomolecules can be rapidly formed without requiring a large quantity of sample or considerable time and effort, as well as interaction between biomolecules can be detected in real time.

Furthermore, according to the first aspect of the present invention, the melting temperature of biomolecule can be measured and sequencing of nucleic acid, for example, detection of single nucleotide polymorphisms can be carried out.

According to the second aspect of the present invention, a target biomolecule can be concentrated in the vicinity of the array surface, permitting rapid and highly sensitive interaction between biomolecules.

### BEST MODE FOR CARRYING OUT THE INVENTION

### First Aspect

The first aspect of the present invention will be described in greater detail below.

### [Device of Testing Interaction Between Biomolecules]

The device of testing interaction between biomolecules of the present invention will be described based on FIG. 1. FIG. 1 is a schematic diagram of the device of the present invention.

The device of testing interaction between biomolecules of the present invention comprises a biomolecule microarray (1) in which a biomolecule is immobilized on a substrate and a transparent electrode (2) (opposite electrode) positioned so as to face the surface of the substrate of said microarray on which the biomolecule is immobilized, comprises a nonconductive spacer between said microarray (1) and said opposite electrode (2), and a cavity (4) is formed by said microarray (1), said spacer (3) and said opposite electrode (2), and said microarray (1) comprises a conductive material surface (6) on at least a portion of the surface on which the biomolecule is immobilized, as well as comprises two through-holes (5) communicating with said cavity (4), one of which is a hole for introducing a solution into the cavity, and the other of which is a hole for discharging a solution from the cavity.

The aforementioned biomolecule can be at least one selected from the group consisting of DNA, RNA, PNA, protein, polypeptide, sugar compound, lipid, natural small molecule, and synthetic small molecule. It can be selected based on the objective.

Examples of the sugar compound are monosaccharides, oligosaccharides, polysaccharides, sugar-chain complexes, glycoproteins, glycolipids, and derivatives thereof.

Examples of the lipid are fatty acids, phospholipids, glycolipids, and glycerides.

Examples of the natural small molecule are hormone molecules, antibiotic substances, poisons, vitamins, physiologically active substances, and secondary metabolites.

Examples of the synthetic small molecule are synthetic products of natural small molecules and derivatives thereof.

Examples of the interaction between biomolecules that can be tested by the device of the present invention are hybridization of probe nucleic acid and target nucleic acid, antigen-antibody interaction, receptor-ligand interaction, protein-protein interaction, and DNA-protein interaction.

The microarray (1) is prepared by immobilizing a biomolecule on a substrate, and has a conductive material surface (6) on at least a portion of the surface on which the biomoleule is immobilized. The conductive material included in the conductive material surface can be, for example, metals (such as gold, nickel, platinum, silver, titanium, aluminum, stainless steel, and copper), conductive oxides (such as In₂O₅/SnO₂), and conductive plastics (such as polyacetylene). In case that the substrate has a protruding spot part and automatic gridding is conducted by a reflected image, the conductive material is selected from among optically reflective materials.

When employing a bond of metal and thiol group to immobilize probe nucleic acid, the conductive material is selected from among metals having the ability to bind with a thiol group.

The substrate can be one comprising a spot (protruding spot part) for immobilizing a biomolecule which protrudes from the surface of the substrate and comprises a flat surface for spotting on the top thereof, at least said protruding spot part comprises a conductive material surface, a biomolecule is immobilized on the conductive material surface of said flat surface for spotting, as well as comprising a terminal capable of passing an electric current to said conductive material surface of the protruding spot part on the surface of said substrate in areas other than the protruding spot part. Said surface of the substrate in areas other than the protruding spot part can comprise a conductive material coating layer, as well as said terminal can be comprised in said conductive material coating layer or capable of passing an electric current to said conductive material coating layer. Furthermore, it is preferable that said conductive material coating layer and the conductive material surface of the protruding spot part are provided as an integrated conductive material coating layer. Examples of such a substrate are a substrate (substrate I) in which at least the substrate surface around the protruding spot part, the lateral surface of the protruding spot part, and the flat surface for spotting are comprised of a conductive material, or a substrate (substrate II) in which adjacent protruding spot parts are adjoined through the lateral surfaces of the protruding spot parts, as well as at least the lateral surfaces of the protruding spot parts and the flat surface for spotting are comprised of a conductive material.

In substrates I and II, the spot for immobilizing a biomolecule is provided on the flat surface on the top of the protruding spot part. Thus, in substrates I and II, the flat surface for spotting (spot for immobilizing a biomolecule) on the top of the protruding spot part is located in position somewhat higher that the surface of the substrate around the protruding spot part, creating a difference in height between the two.

Additionally, a confocal detector that can be employed to test interaction between biomolecules in the present invention, as described below, detects fluorescence and reflected light from the focal surface on the sample through pinholes formed in the image-forming surface of an optical system. FIG. 2 shows a schematic diagram of the optical system of the confocal detector 40 employed in the present invention. In FIG. 2, solid line a denotes incident light. Solid line b denotes reflected light or fluorescence from the focal surface. The broken line denotes fluorescence or reflected light from the nonfocal surface. In confocal detector 40, light reflected from the focal surface on microarray 1 and fluorescence released from the focal surface on the sample pass through an object lens 42 and enter a beam splitter 43. Beam splitter 43 corrects the optical path so that the light enters detection lens 44 perpendicularly. The light passes through detection lens 4 and strikes image-forming surface 45. Confocal detector 40 is designed so that the focal point on the sample is also the focal point on the image-forming surface. Thus, light from the focal surface on the sample comes into focus on image-forming surface 45, passes through pinhole 46, and is detected by detection element 47. Additionally, since light from the nonfocal surface on the sample does not come into focus on image-forming surface 45, most of the light does not pass through pinhole 46 and is not detected by detection element 47. In this manner, light from the focal surface can be selectively detected by a confocal detector.

On the above substrate I, when the difference in height between the substrate surface around the protruding spot parts and the flat surface on the top of the protruding spot parts (spots for immobilizing a biomolecule) is greater than the focal depth of the confocal detector employed to detect interaction between biomolecules and target biomolecules, the focal point of the confocal detector can be adjusted to the height of the flat surface on the top of the protruding spot part so that fluorescence and reflected light from the flat surface on the top of the protruding spot part will be detected at higher intensity than fluorescence and light reflected from the substrate surface around the protruding part. Accordingly, in the device comprising a microarray in which a biomolecule is immobilized on the flat surface on the top of a protruding spot part on the substrate I, information on the spots such as the presence or absence of interaction with a target biomolecule can be detected with high sensitivity.

The above substrate II is characterized in that the protruding spot parts adjacent each other border through the lateral surface of the protruding spot part, and at least said lateral surface of the protruding spot part and the flat surface for spotting are comprised of a conductive material. FIG. 3 shows an example of substrate II.

On substrates I and II, the angle formed between the flat surface for spotting on the top of the protruding spot part and the lateral surface of the protruding spot part is preferably equal to or greater than 90 degrees, more preferably 90 to 135 degrees. FIG. 4(a) is a cross-sectional view of a portion of the substrate of the present invention. Here, the phrase, “the angle formed between the flat surface for spotting on the top of the protruding spot part and the lateral surface of the protruding spot part” refers to angle θ in FIG. 4(a). For example, the angle θ can be measured from the cross section obtained by cutting the protruding spot part perpendicularly with respect to the substrate surface around the protruding spot.

In this manner, on substrates I and II, having the angle formed between the flat surface for spotting on the top of the protruding spot part and the lateral surface of the protruding spot part be equal to or greater than 90 degrees, that is, having the size of the bottom surface of the protruding spot part be greater than the size of the flat surface on the top of the protruding spot part, is advantageous in that it permits specification of the position and size of the spot for immobilizing a biomolecule. This point will be described in detail below.

As shown in FIG. 4(a), in the course of detecting reflected light using a confocal detector, light reflected from the lateral surface of a protruding spot part, corresponding to light irradiated from a direction perpendicular to the flat surface on the top of the protruding spot part (the light indicated by the arrow in FIG. 4(a)), does not reflect in the same direction as incident light when the angle formed between the flat surface for spotting on the top of the protruding spot part and the lateral surface of the protruding spot part is equal to or greater than 90 degrees. In contrast, light reflected from the flat surface for spotting on the top of a protruding spot part reflects in the same direction as incident light. Thus, in a confocal detector, only light reflected from the flat surface for spotting on the top of a protruding spot part is detected; light reflected from the lateral surface is not detected. In the reflected image thus obtained, the image corresponding to the flat surface for spotting on the top of the protruding spot part is obtained as a reflected image. Most of portions corresponding to the lateral surface of the protruding spot part are not detected in a reflected image, and thus appear as a black fringe. In the reflected image, the interior of the black fringe corresponds to the biomolecule spot. Thus, this reflected image can be used to specify the size and position of the spot. In the present invention, based on this principle, it is possible to automate gridding.

On substrate I, when the height of the protruding spot part is greater than or equal to the focal depth of the confocal detector employed to detect interaction, the focal point of the confocal detector can be adjusted to the height of the flat surface for spotting on the top of the protruding spot part. Thus, since light reflected from the substrate surface around the protruding spot part has a different focal point, it is only detected at an intensity much weaker than that of light reflected from the flat surface for spotting on the top of the protruding spot part. In the present invention, this height difference can be exploited to conduct automated gridding. However, even when the height of the protruding spot part is less than the focal depth of the confocal detector used to detect interaction, as stated above, when the portion corresponding to the lateral surface of the protruding spot part appears as a black fringe in a reflected image, it is possible to specify the size and position of the spot.

Further, on substrate I, even when the angle formed between the flat surface for spotting on the top of the protruding spot part and the lateral surface of the protruding spot part is less than 90 degrees, when the height of the protruding spot part is greater than or equal to the focal depth of the confocal detector employed to detect interaction, the difference in height between the flat surface for spotting and the substrate surface around the protruding spot part can be exploited to specify the position and size of the flat surface for spotting based on reflected light, and automated gridding can be conducted. When the angle formed between the flat surface for spotting on the top of the protruding spot part and the lateral surface of the protruding spot part is 90°, the protruding spot part can be in the shape of a cylindrical column or a square rod.

Further, on substrate I, the angle formed between the flat surface for spotting on the top of the protruding spot part and the lateral surface of the protruding spot part can be equal to or greater than 90 degrees and the substrate surface around the protruding spot part can form a roughly V-shaped bottom surface. On such a substrate, the intensity of light reflected from the flat surface for spotting that is detected by the confocal detector is greater than the intensity of light reflected from portions other than the flat surface for spotting on the substrate. Thus, this difference in the intensity of reflected light can be used to specify the position and size of the flat surface for spotting. FIG. 5 is a partially enlarged view of a substrate having a “roughly V-shaped bottom surface.” In the present invention, the phrase “roughly V-shaped bottom surface” means that the substrate surface around a protruding spot part between adjacent protruding spot parts is not flat, but as shown in FIG. 5, is roughly V-shaped.

In substrate I, at least the surface of the substrate around the protruding spot part, the lateral surface of the protruding spot part, and the flat surface for spotting are comprised of a conductive material. In view of the ease and cost of manufacturing, in substrate I, the substrate surface other than around the protruding spot parts is also desirably comprised of a conductive material. Further, in substrate II, at least the lateral surface of the protruding spot part and the flat surface of the protruding spot part are comprised of a conductive material.

In the present invention, in substrate I, at least the surface of the substrate around the protruding spot part, the lateral surface of the protruding spot part, and the flat surface for spotting, and in substrate II, at least the lateral surface of the protruding spot part and the flat surface for spotting, are comprised of a conductive material. Thus, as will be described further below, an electrode is provided opposite the microarray (1) prepared by immobilizing a biomolecule on the substrate and an electric field is applied to promote interaction between the biomolecule immobilized on the flat surface for spotting and a target biomolecule. For example, it is possible to achieve good interaction results even when the concentration of the target biomolecule is low. Further, when the concentrations are identical, it is possible to achieve a prescribed interaction result in a short period.

Further, in the first aspect, when the above conductive material reflects light, the reflected light can be used to specify the size and position of biomolecule-immobilized spots to conduct automated gridding. This point will be described further below.

In the present invention, the height of the protruding spot part can be suitably set to be identical to or greater than the focal depth of the confocal detector employed to detect interaction. In view of the focal depth of the usual confocal detector, the height of the protruding spot part can be from 10 to 500 micrometers, for example. However, as set forth above, when conducting automated gridding based on detection of the difference in intensity of reflected light based on the difference in shape between the flat surface on the top of the protruding spot part and other portions on the substrate, automated gridding can be conducted even when the height of the protruding spot part is smaller than the focal depth of the confocal detector employed to detect interaction. This point will be described further below.

Further, in the course of setting the height of the protruding spot part, it is also necessary to consider the diameter of the needle employed to form spots of biomolecules (stamping) and the spotting amount of the solution of a biomolecule such as probe nucleic acid. For example, when employing a needle with a diameter of about 130 micrometers to spot biomolecules on the round protruding spot parts 100 micrometers in diameter, a protruding spot part having a height of greater than or equal to 15 micrometers is desirable because surface tension prevents the biomolecule solution from flowing out of the flat surface for spotting on the top of the protruding spot part and thus biomolecules are immobilized only on the spots for immobilizing.

On the substrate having a protruding spot part, the shape of the flat surface for spotting on the top of the protruding spot part can be any shape so long as the biomolecules spotted can be held. For example, the shape may be round or square. The size of the above flat surface for spotting can be suitably set based on the needle employed in spotting and the amount of biomolecule solution that is spotted. For example, it can be 10 to 500 micrometers. Here, the phrase “size of the flat surface for spotting” refers to the diameter when, for example, the flat surface for spotting is round in shape, and to the length of a side when the flat surface for spotting is square in shape.

The shape of the bottom surface of the protruding spot part is not specifically limited. In consideration of the ease of manufacture, this shape is desirably identical to the shape of the flat surface for spotting. FIG. 4(b) is a schematic diagram of a protruding spot part on the substrate having a protruding spot part. Here, the phrase, “the shape of the bottom surface of the protruding spot part” refers to the hatched portion in FIG. 4(b).

The flat surface for spotting on the top of the protruding spot part can be a roughened surface. For example, on the flat surface for spotting on the top of the protruding spot part, there may be irregularities with a depth within the focal depth of the confocal detector employed to detect interaction in a roughly horizontal direction to a depth direction. FIG. 6 shows an example (partially enlarged view) of a roughened flat surface for spotting. The flat surface for spotting provided with a lattice-like shape with squares of several micrometers, as shown in FIG. 6, is an example of a roughened flat surface for spotting. By roughening the flat surface for spotting in this manner, as described further below, a strong electric field is generated at the edges of the irregularities when concentrating the target biomolecule by electrophoresis or dielectrophoresis, affording the advantage of further promoting interaction.

The method of roughening the flat surface for spotting is not specifically limited. For example, when the substrate employed in the present invention is a molded plastic substrate, a substrate with roughened flat surfaces for spotting can be prepared using a finely processed mold obtained by reverse transferring, with electroforming, a base material that has been etched by photolithography.

The whole of the above substrate can consiss of a conductive material or the above substrate can comprise a conductive material coating layer on the surface of the substrate. In addition, when a probe nucleic acid is immobilized using the bond of metal and a thiol group, the conductive material is selected from among metals having the ability to bind with a thiol group.

Examples of the substrate having a conductive material coating layer are glass, quartz, silicon, and plastic substrates—specifically, polypropylene substrates—the surfaces of which have been coated with the above-described conductive material. The thickness of the conductive material coating layer on the substrate is not specifically limited, and can be 0.1 to 10 micrometers, for example.

A method of manufacturing the above substrate in the form of a substrate having spots (protruding spot parts) for immobilizing a biomolecule, where the spots protrude from the surface of the substrate and have flat surfaces for spotting present on their tops as set forth above, will be described.

When the substrate is comprised of metal, the substrate of the present invention can be cast by pouring molten metal into a casting mold having indentations corresponding to protruding spot parts of desired shape. A metal substrate can also be obtained by press molding. The substrate of the present invention can also be in the form of a metal substrate coated with a conductive material.

When the substrate of the present invention has a coating of a conductive material on a substrate made of silicon or plastic, for example, the substrate of the present invention can be obtained by molding silicon or plastic with a pressing mold having indentations corresponding to protruding spot parts of desired shape and coating the substrate made of silicon or plastic with a conductive material by vapor deposition, plating, or the like.

The substrate having a protruding spot part can also be manufactured by applying an electrically conductive coated layer to a flat substrate and then forming protruding spot parts by etching or the like.

Substrates not having a protruding spot part can be manufactured by known methods or can be obtained as commercial products.

An example of a method of manufacturing the substrate having a protruding spot part of the present invention when it comprises a gold coating layer on a glass substrate will be described below. However, the present invention is not limited to this form.

First, a vacuum vapor deposition device is used to vapor-deposit chromium on the surface of a glass slide. Next, gold is vapor-deposited thereover. Positive resist is then applied by spin coating to the glass slide that has been vapor-deposited with gold, and the substrate is baked for one hour in an oven at 60° C., for example.

Next, the glass slide is irradiated with ultraviolet radiation through a photomask using a UV exposure device. The photomask employed has a pattern corresponding to protruding spot parts of desired shape. Following UV irradiation, development is conducted with a developing solution to form a resist pattern on the surface of the gold-deposited glass slide.

Next, the gold surface around the resist pattern is etched with a gold etchant. Following etching of gold, the substrate is washed with ultrapure water, again etched with an etchant to remove the chromium deposited under the gold, and washed with ultrapure water.

After dissolving the resist with acetone or the like, the substrate is washed with ultrapure water, immersed in piranha solution (sulfuric acid: hydrogen peroxide=1:1) for 10 minutes, for example, to completely remove any remaining resist, and then washed with ultrapure water. This yields a glass substrate having a gold pattern corresponding to the photomask.

Next, the above substrate is immersed in hydrofluoric acid to etch the exposed glass surface. The concentration of the hydrofluoric acid employed and the immersion time can be suitably set based on the desired height of the protruding spot parts.

Next, in the same manner as above, gold, chromium and the like are etched and the substrate is cleaned with piranha solution and ultrapure water, yielding a glass substrate having protruding spot parts of desired shape.

This glass substrate can be vapor-deposited with chromium and then gold in the same manner as above to obtain a substrate having both protrusions and a gold coating.

Neither the overall size of the above substrate, the number of protruding spot parts on the substrate, nor their degree of integration is limited; these may all be suitably set. For example, in the present invention, the substrate employed may be in the form of a substrate 10 to 20,000 mm² in size having roughly from 10 to 50,000 protruding spot parts.

When the biomolecule immobilized on the substrate is nucleic acid and the conductive material included in the conductive material surface (6) is metal, to immobilize the probe nucleic acid on the substrate, a solution containing nucleic acid having on one end a group reactive with the metal included in the conductive material surface (6) on the substrate can be employed as a spotting solution. An example of such a group is a thiol group. A nucleic acid chain having a thiol group can be immobilized on a metal surface by known methods. For example, see J. Am. Chem. Soc. 1998, 120, 9787-9792.

The following methods of processing a metal (where a surface oxide coating is activated so as to present hydroxyl groups) may be employed as the method of immobilizing DNA on a metal surface:

(1) Immobilization of DNA on a substrate surface processed with aminosilane by UV irradiation;

(2) Immobilization of biotinylated DNA on a substrate surface that has been sequentially treated with aminosilane, NHS (N-hydroxysuccinimide)-biotin, and avidin.

(3) Immobilization of biotinylated DNA on a substrate surface that has been sequentially treated with aminosilane, maleimide-biotin, and avidin.

(4) Immobilization of aminated DNA on a substrate surface that has been treated with aminosilane followed by glutaldehyde.

(5) Immobilization of aminated DNA on a substrate surface that has been treated with aminosilane followed by carbodiimide.

(6) Immobilization of carboxylated DNA on a substrate surface that has been treated with aminosilane.

(7) Immobilization of phosphorylated DNA on a substrate surface that has been treated with aminosilane.

(8) Immobilization of thiolated DNA on a substrate surface that has been treated with aminosilane followed by an NHS-maleimide compound.

(9) Immobilization of aminated DNA on a substrate surface that has been treated with epoxysilane.

(10) Immobilization of thiolated DNA on a substrate surface that has been treated with thiolsilane.

Biomolecules other than DNA can also be immobilized by UV irradiation or through a functional group such as a thiol group, amino group, carboxyl group, phosphoric acid group, or the like as set forth above.

A biomolecule solution can be spotted onto the above conductive material surface (6) by a known method. For example, a needle containing biomolecule solution in its tip can be brought into contact with the substrate surface at positions where biomolecules are to be immobilized. Here, when the substrate has a protruding spot part, the flat surface for spotting on the top of the protruding spot part can be touched to spot the biomolecules. Examples of the spotting device employed are described in Japanese Unexamined Patent Publication (KOKAI) Nos. 2001-46062 and 2003-57236. The spot amount can be suitably set. When the above-described protruding spot part is present on the substrate, the spot amount can be suitably set based on the size of the flat surface for spotting and the height of the protruding spot part so that the biomolecule solution does not run off the flat surface for spotting.

In the device of the present invention, a transparent electrode (2) (opposite electrode) is positioned so as to face the surface of the substrate of said microarray on which the biomolecule is immobilized. In the present invention, the electric field density increases between the flat surface on which the biomolecule is immobilized and the surface of the opposite electrode facing the above flat surface by applying an electric field between the microarray and the opposite electrode. The target biomolecules in the solution are concentrated in the vicinity of the spot on which the biomolecule is immobilized by electrophoresis (when a direct current power source is employed) or dielectrophoresis (when an alternating power source is employed). Thus, interaction between the biomolecule immobilized on the substrate and the target biomolecule can be promoted. This effect is marked when a substrate having the above-described protruding spot parts is employed. In particular, when the flat surface for spotting on which the biomolecule is immobilized is a roughened surface, for example, irregularities having a depth within the focal depth of a confocal detector are provided in a roughly horizontal direction to a depth direction on the flat surface for spotting, such advantages can be obtained that an intense electrical field is produced at the edge of the irregularities and thus the interaction is further promoted.

The opposite electrode is not specifically limited other than that it be transparent and permit the application of an electric field between itself and the biomolecule microarray. The use of such a transparent electrode permits the detection of reflected light and/or fluorescence by the confocal detector from above the transparent electrode while introducing or maintaining solution into the cavity, permitting the detection of interaction between biomolecules in real time.

In the present invention, the opposite electrode is comprised of a transparent, conductive material such as a substrate comprised of a conductive oxide or conductive plastic. It may also be comprised of a substrate having a conductive material coating layer on the surface facing the microarray. The opposite electrode is desirably comprised of a conductive oxide such as ITO (indium tin oxide) or tin oxide.

Further, in the device of the present invention, the power source for applying an electric field between the microarray (1) and the opposite electrode (2) may be either a direct current or alternating current power source. An alternating current power source is preferably employed. When employing a direct current power source and applying a high voltage, there is a risk that the target biomolecule solution will be electrically degraded by the high voltage and that bubbles will appear. Thus, the use of a low voltage is desirable when employing a direct current power source. When employing DNA as the target biomolecule and using a direct current power source, the electric field is desirably applied so that the protruding spot part side is made the positive side, since DNA is negatively charged. When employing an alternating current power source, the frequency can be 10 Hz to 1. MHz, for example.

The device of the present invention comprises a nonconductive spacer between said microarray (1) and said opposite electrode (2), and a cavity (4) is formed by said microarray (1), said spacer (3) and said opposite electrode (2). The above microarray (1) comprises two through-holes (5) communicating with said cavity (4), one of which is a hole for introducing a solution into the cavity, and the other of which is a hole for discharging a solution from the cavity. Thus configured, the device of the present invention permits the introduction of solution into cavity (4), thereby making it possible to test interaction between biomolecules in real time through transparent electrode (2) while introducing a solution containing the target biomolecules. It is also possible to observe the state of interaction between biomolecules in the cavity while varying the concentration of the target biomolecules in the solution during introduction, or while introducing solution not containing the target biomolecule for cleaning.

The nonconductive spacer can be manufactured by die cutting a sheet of polyethylene terephthalate (PET), polyethylene naphthalene, or silicon film to form a hole corresponding to cavity (4), for example. The material of the spacer is not limited to the above, and may be suitably selected based on consideration of ease of processing or the like.

In the device of the present invention, the distance between the microarray (1) and the opposite electrode (2) can be controlled by the thickness of the nonconductive spacer (3). To promote interaction between biomolecules by applying an electric field, the distance between the surface of the microarray (1) on which the biomolecules have been immobilized and the surface of the opposite electrode (2) facing the surface of the microarray (1) on which the biomolecules have been immobilized is desirably 10 to 300 micrometers. The thickness of nonconductive spacer (3) can be suitably set taking into account the distance between the surface of the microarray (1) on which the biomolecules have been immobilized and the surface of the opposite electrode (2) facing the surface of the microarray (1) on which the biomolecules have been immobilized. For example, this distance can be 10 to 300 micrometers.

The nonconductive spacer may have adhesive layers on both surfaces thereof. These adhesive layers may be employed to adhere the nonconductive spacer to the microarray (1) and opposite electrode (2). By adhering one surface of nonconductive spacer (3) to the microarray (1) and the other surface to the opposite electrode (2), the cavity (4) can be formed in the hole portion provided in the above-described spacer seal. This can constitute the device of the present invention having a cavity formed by the microarray (1), nonconductive spacer (3), and opposite electrode (2).

The adhesive of the above adhesive layers desirably contains a photosetting resin. Since photosetting resins set and lose their adhesive strength when irradiated with light, incorporating a photosetting resin into the photosetting adhesive makes it possible to remove the microarray (1) and the opposite electrode (2) from the nonconductive spacer (3) by irradiation with light. A known photosetting resin such as a UV-curing resin may be employed as the photosetting resin.

The device of the present invention has a means for connecting the conductive material surface (6) on said microarray (1) and the opposite electrode (2) to an external power source from the side of the microarray (1).

As set forth above, the device of the present invention has two through-holes (5) communicating with cavity (4) in the microarray (1), it being possible to introduce solution through these through-holes. The use of a configuration permitting the application of an electrical field between the conductive material surface (6) on the microarray (1) and opposite electrode (2) from the microarray side as set forth above makes it possible to introduce solution and apply an electric field from the microarray (1) side, thereby permitting the smooth observation of interaction between the biomolecules from the opposite electrode (2) side without hindrance.

A specific example of a device having such a means is the device having the configuration shown in FIG. 1, further comprising a conductive stuff (7) at least a portion of which contacts the conductive material surface (6) of said microarray (1) and does not contact said opposite electrode (2), and the conductive material surface (6) on said substrate is connected through said conductive stuff (7) to the external electric source. Examples of the conductive material included in the conductive stuff (7) are metal, nickel, platinum, silver, titanium, aluminum, stainless steel, copper, chromium, conductive oxides (such as In₂O₅/SnO₂), and conductive plastics (such as polyacetylene).

In the device having the above structure, as shown in FIG. 1, a through-hole (8) communicating with the conductive stuff (7), and a through-hole (9) communication with the opposite electrode (2) can be provided in the microarray (1), with the conductive material surface (6) on the microarray (1) and opposite electrode (2) being connected to an external power source through through-holes (8) and (9) to apply an electric field between the microarray (1) and opposite electrode (2).

The through-holes can be formed during molding when the microarray substrate is molded with a metal mold, for example. The through-holes may also be formed by cutting with dies or the like.

The device of the present invention desirably further comprises a temperature control means, such as a heater. The temperature control means can regulate the environment around the biomolecules to a temperature suited to interaction, thereby promoting the interaction. In particular, the temperature control means is desirably positioned on the microarray side. This permits regulation of the temperature without interfering with observation from the opposite electrode (2) side.

### [Method of Testing Interaction Between Biomolecules]

One embodiment of the method of testing interaction between biomolecules of the present invention (also referred to as “test method I”, hereinafter) is:

a method of testing interaction between biomolecules using a device comprising a biomolecule microarray (1) in which a biomolecule is immobilized on a substrate and a transparent electrode (2) (opposite electrode) positioned so as to face the surface of said microarray on which the biomolecule is immobilized, as well as comprising a nonconductive spacer between said microarray (1) and said opposite electrode (2) in which a cavity (4) is formed by said microarray (1), said spacer (3) and said opposite electrode (2), wherein

said microarray (1) comprises a conductive material surface (6) on at least a portion of the surface on which the biomolecule is immobilized, as well as

said method comprises:

applying an electric field between said microarray (1) and said opposite electrode (2),

while introducing a solution comprising a target biomolecule and/or a solution not comprising a target biomolecule into said cavity (4), optically detecting through said opposite electrode interaction between said biomolecule on the microarray and said target biomolecule.

Another aspect of the method of testing interaction between biomolecules of the present invention (also referred to as “test method II”, hereinafter) is:

a method of testing interaction between biomolecules using a device comprising a biomolecule microarray (1) in which a biomolecule is immobilized on a substrate and a transparent electrode (2) (opposite electrode) positioned so as to face the surface of said microarray on which the biomolecule is immobilized, as well as comprising a nonconductive spacer between said microarray (1) and said opposite electrode (2) in which a cavity (4) is formed by said microarray (1), said spacer (3) and said opposite electrode (2), wherein

said microarray (1) comprises a conductive material surface (6) on at least a portion of the surface on which the biomolecule is immobilized, as well as

said method comprises:

applying an electric field between said microarray (1) and said opposite electrode (2),

filling said cavity (4) with a solution comprising a target biomolecule, maintaining the solution in the cavity for a prescribed period, and then discharging said solution, and

optically detecting through said opposite electrode interaction between said biomolecule on the microarray and said target biomolecule while said solution is being maintained or after said solution has been discharged.

The above-described device of testing interaction between biomolecules of the present invention can be employed in both test methods I and II.

Test method I comprises applying an electric field between said microarray (1) and said opposite electrode (2), while introducing a solution comprising a target biomolecule and/or a solution not comprising a target biomolecule into said cavity (4), optically detecting through said opposite electrode interaction between said biomolecule on the microarray and said target biomolecule. Based on test method I, while applying an electric field between the microarray (1) and opposite electrode (2) to promote interaction between biomolecules in this manner, the interaction between biomolecules can be observed in real time through opposite electrode (2) while introducing a solution. Further, interaction between biomolecules on the microarray and target biomolecules is initially induced by introducing a solution containing target biomolecules while applying an electric field, after which the state of interaction between biomolecules in the cavity is observed through the opposite electrode while introducing a solution not containing target biomolecules to clean out the cavity. Further, interaction between biomolecules can be observed while sequentially varying the concentration of the target molecules in the solution being introduced into the cavity.

By contrast, test method II comprises applying an electric field between said microarray (1) and said opposite electrode (2), filling said cavity (4) with a solution comprising a target biomolecule, maintaining the solution in the cavity for a prescribed period, and then discharging said solution, and optically detecting through said opposite electrode interaction between said biomolecule on the microarray and said target biomolecule while said solution is being maintained or after said solution has been discharged. In this manner, based on test method II, an electric field can be applied between the microarray (1) and opposite electrode (2) to promote interaction between the biomolecules while filling cavity (4) with a solution containing target biomolecules and maintaining the solution in the cavity for a prescribed period. The interaction can be observed through the opposite electrode (2), either while the target biomolecules are being maintained within the cavity or after they have been discharged from it. Further, in test method II, the cavity can be newly filled with a solution containing target biomolecules and/or a solution not containing target biomolecules to replace the solution within the cavity, either after the solution containing target biomolecules has been discharged or while it is being discharged.

In test methods I and II, the electric field that is applied between the microarray (1) and opposite electrode (2) can be suitably set within a range over which an effect of concentrating target biomolecules is achieved by electrophoresis or dielectrophoresis while taking into account the distance between the microarray (1) and opposite electrode (2). For example, an electric field of 0.01 to 10 MV/m can be employed. As will be described further below, the electric field that is applied is desirably suitably set based on the type of buffer employed in the target biomolecule solution to achieve a high interaction promoting effect.

In test methods I and II, it is preferable that the conductive material surface (6) on said microarray (1) and the opposite electrode (2) are connected to an external power source from the side of said microarray (1) to apply an electric field between said microarray (1) and said opposite electrode (2). When employing the device of testing interaction between biomolecules of the present invention having a through-hole (8) communicating with the above conductive stuff (7) and a through-hole (9) communicating with the above opposite electrode (2), by connecting the above conductive stuff (7) and the opposite electrode (2) to a terminal of the external power source through the through-hole (8) communicating with the conductive stuff (7) and the through-hole (9) communicating with the opposite electrode (2), the conductive material surface (6) on the microarray (1) and the opposite electrode (2) can be connected to the external power source from the microarray (1) side, making it possible to apply an electric field between the above microarray (1) and opposite electrode (2).

Further, in test methods I and II, when employing the device of testing interaction between biomolecules of the present invention, through the through-hole (5) communicating with the cavity comprised in the microarray (1), a solution can be introduced to, and/or discharged from, the cavity.

When the solution is introduced and the connection to an external power source is made from the microarray (1) side in this manner, it becomes possible to smoothly observe the interaction between biomolecules from the opposite electrode (2) side without hindrance.

The above-described solution containing target biomolecules (also referred to as “target biomolecule solution”, hereinafter) may contain a buffer. Examples of buffers employed in the target biomolecule solution are those having a dissociation constant (pKa) of about 6 to 8. To efficiently conduct hybridization of probe nucleic acid and target nucleic acid, it is desirable for the pH to be in the neutral range. Thus, it is desirable to employ a buffer having buffering ability in the neutral range. Specific examples are buffers containing the following buffering substances: phenylalanine, carnosine, arginine, histidine, MES (2-(N-morpholine)ethanesulfonic acid), maleic acid, 3,3-dimethylglutaric acid, carbonic acid, 4-hydroxymethylimidazole, citric acid, dimethylaminoethylamine, praline acid, glycerol-2-phosphoric acid, PIPES (piperazine-N,N′-bis(2-ethanesulfonic acid), ethylenediamine, imidazole, MOPS (3-(N-morpholine)propanesulfonic acid), phosphoric acid, TES (N-tris(hydroxymethyl)methyl-2-aminoethanesulfonic acid), 4-methylimidazole, HEPES (N-2-hydroxyethylpiperazine-N′-2-ethanesulfonic acid), N-ethylmorpholine, triethanolamine, and tris(tris(hydroxymethyl)aminomethane).

When the conductivity of the buffer employed in the target biomolecule solution is excessively high, there is a risk that the migration of ions in the buffer may reduce the concentrating effect on target biomolecules. Accordingly, in the present invention, a buffer with a conductivity of 10 to 500 microohms⁻¹/m is desirable, with the use of a buffer with a conductivity of 10 to 100 microohms⁻¹/m being preferred. When the conductivity of the buffer falls within the above-stated range, interaction between biomolecules can be readily promoted. The concentration of the buffer is desirably suitably adjusted to achieve conductivity falling within the above-stated range.

From the above perspectives, specific examples of preferred buffers are buffers containing the following buffer substance: phenylalanine, histidine, carnosine, or arginine. Particularly high hybridization signal intensity can be achieved when conducting hybridization of probe nucleic acid and target nucleic acid using a target biomolecule solution containing phenylalanine. Further, the application of an electric field can produce a hybridization signal intensity of two-fold or greater, for example, relative to when hybridization is conducted without the application of an electric field. Thus, phenylalanine is a buffer substance that is particularly effective in the present invention in which an electric field is applied to promote interaction between biomolecules.

The electric field applied between the microarray and the electrode is desirably suitably set based on the buffer employed to achieve a strong promoting effect on interaction between biomolecules. For example, an electric field ranging from 0.5 to 1.0 MV/m is desirably applied when employing phenylalanine, 0.5 to 1.0 MV/m when employing histidine, 0.25 to 0.75 MV/m when employing carnosine, and 0.1 to 0.3 MV/m when employing arginine as buffer.

In test methods I and II, interaction between the biomolecules on the microarray (1) and the target biomolecules is optically detected through opposite electrode (2). Examples of the optical detection method are methods employing fluorescence detectors, confocal detectors, confocal laser fluorescence microscopes, and fluorescence microscopes. Of these, it is desirable for the target biomolecules to be labeled with a fluorochrome when employing a confocal detector to detect the interaction between biomolecules by detecting fluorescence. The target biomolecules can be labeled with a fluorochrome by known methods. In the present invention, the biomolecules that are immobilized on the microarray (1) can also be labeled with a fluorochrome. Known methods can be used to label the biomolecules that are immobilized on the microarray with a fluorochrome.

The above-described device of testing the interaction between biomolecules of the present invention having a protruding spot part on a substrate can be employed in the method of testing the interaction of biomolecules of the present invention. In this case, interaction between the biomolecule on the microarray and the target biomolecule can be detected by a confocal detector through the opposite electrode. The principle of detection of reflected light and fluorescence using a confocal detector is as set forth above. In the interaction test of the present invention, when employing the device of testing interaction between biomolecules of the present invention having a protruding spot part on a substrate, automatic gridding can be conducted using a confocal detector by specifying the size and position of spots based on a reflected image according to the above-described principle. That is, the protruding spot part on the microarray can be detected as a reflected image from the difference in intensity of reflected light based on differences in the height and/or shape of the protruding spot part on the surface of the microarray and other portions on the surface of the microarray. Further, a fluorescent image corresponding to the spot can be obtained by selectively detecting the fluorescence from the protruding spot part, that is, the fluorescence of fluorescently labeled biomolecules (biomolecules immobilized on spots and/or target biomolecules) on the flat surfaces for spotting by matching the focal point of the confocal detector to the height of the flat surfaces for spotting on the top of protruding spot parts on the microarray when detecting fluorescence from the microarray with a confocal detector. In the present invention, the reflected image and fluorescent image thus obtained can be superposed to specify spots on which interaction is occurring on the microarray, and based on the fluorescent intensity, measure the degree of interaction. In the present invention, a fluorescent intercalator specifically staining a double stranded nucleic acid can be employed and the interaction can be detected by measuring fluorescence from the intercalator.

In the present invention, the use of a confocal scanner capable of simultaneously detecting reflected light and fluorescence is particularly desirable. FIG. 7 shows an example of such a device. In the device shown in FIG. 7, an excitation beam generated by excitation light source (laser) 21 passes through mirror 22, dichroic mirror 23, mirror 26, and object lens 24, where it is directed onto a sample (microarray) 25. The reflected light passes through object lens 24, mirror 26, dichroic mirror 23 (which passes some of the reflected light (not more than several percent)), dichroic mirror 27, light reducing filter 28, detection lens 29, and pin hole 30, where it is directed onto reflected light detecting element 31. The fluorescence passes through two dichroic mirrors 23 and 27, reflects off mirror 32, and passes through cut filter 33, detection lens 34, and pin hole 35, where it is directed onto fluorescence detecting element 36. Based on this device, the protruding spot part on the microarray can be detected as reflected images from the difference in intensity of reflected light based on differences in the height and/or shape of the protruding spot part and other portions on the surface of the microarray while simultaneously detecting interaction between biomolecules through the detection of fluorescence from the spots.

### [Method of Measuring Melting Temperature of Biomolecule]

The present invention further relates to a method of measuring a melting temperature of a biomolecule, characterized by using the method of testing interaction between biomolecules of the invention described above.

When a biomolecule, such as nucleic acid, is progressively heated, it undergoes a major change in stereostructure at a certain temperature, and a change equivalent to a phase transition is observed. This temperature is referred to as the melting temperature. In the method of measuring a melting temperature of a biomolecule of the present invention, in the case of biomolecules such as nucleic acid, a solution containing the target nucleic acid and a double strand detecting reagent is maintained in the cavity to cause interaction between probe nucleic acid on the microarray and the target nucleic acid. The temperature within the cavity is progressively raised, and fluorescence from the double strand detecting reagent is detected through the opposite electrode. Thereby, release of the target nucleic acid from the probe nucleic acid within the cavity can be observed in real time, permitting measurement of the melting temperature of the nucleic acid. Ethidium bromide can be employed as the double strand detecting reagent; commercial products such as SYBR (trademark) Green I made by TakaraBio, Inc., can also be used. It is also possible to use fluorescence-labeled target DNA molecules to measure the melting temperature without employing a double strand nucleic acid detecting reagent.

### [Method of Sequencing Nucleic Acid]

The present invention further relates to a method of sequencing a nucleic acid, characterized by using the method of testing interaction between biomolecules of the invention described above.

When probe nucleic acid that is fully complementary with the target nucleic acid is immobilized on a substrate, the target nucleic acid and the probe nucleic acid are hybridized, and the temperature is raised, the melting behavior of the nucleic acid that is observed will differ in the case where probe nucleic acid that is fully complementary with the target nucleic acid is employed and in the case where probe nucleic acid having a partially different base sequence is employed. Accordingly, this difference is utilized in the present invention. Employing the method of testing interaction between biomolecules of the present invention, after hybridizing target nucleic acid and probe nucleic acid, the temperature within the cavity is progressively raised and fluorescence is observed through the opposite electrode, for example, to observe the melting behavior of the target nucleic acid from the probe nucleic acid. On that basis, the sequence of the target nucleic acid can be determined. The method of sequencing nucleic acid of the present invention permits the detection of differences in base sequences from a fully complementary sequence, such as single nucleotide polymorphism (SNP).

### Second Aspect

The second aspect of the present invention will be described in greater detail below.

The second aspect of the present invention relates to a method in which a solution comprising a target biomolecule is placed between a biomolecule microarray comprising one or more spots in which a biomolecule is immobilized on a substrate surface and an electrode (opposite electrode) facing said substrate surface to cause interaction between said biomolecule immobilized on the substrate surface and said target biomolecule, characterized in that

said microarray comprises a conductive material surface on at least a portion of the surface on which the biomolecule is immobilized, and

a voltage at a frequency ranging from 0.01 to 10 Hz is applied between said conductive material surface and said opposite electrode to promote said interaction.

The biomolecules and the interaction are as described for the first aspect above.

The biomolecule array employed in the second aspect of the present invention is prepared by immobilizing a biomolecule on a substrate. A conductive material surface is present on at least a portion of the surface on which the biomolecules have been immobilized. The whole of the substrate can be comprised of a conductive material or the substrate can be a substrate having a conductive material coating layer on the substrate surface.

The conductive material can be, for example, metals (such as gold, nickel, platinum, silver, titanium, aluminum, stainless steel, copper, and chromium); conductive oxides (such as In₂O₅/SnO₂); or conductive plastics (such as polyacetylene). By selecting the conductive material from among metals having the ability of bonding with a thiol, a metal-thiol bond can be used to immobilize the probe nucleic acid. Further, when the substrate has a protruding spot part and automatic gridding is conducted based on a reflected image as described further below, the conductive material can be selected from materials that reflect light.

When the substrate is a substrate comprising a conductive material coating layer, examples of such a substrate includes substrates of glass, quartz, silicon, or plastic, such as polypropylene, the surfaces of which have been coated with a conductive material. The thickness of the conductive material coating layer on the substrate is not specifically limited, and may be 0.1 to 10 micrometers, for example. Such substrates can be prepared by known methods and are available in the form of commercial products.

The substrate employed in the second aspect may have a flat surface. Further, the substrate employed in the second aspect may be one which comprises a spot (protruding spot part) for immobilizing a biomolecule which protrudes from the surface of the substrate and comprises a flat surface for spotting on the top thereof, at least said protruding spot part comprises a conductive material surface, a biomolecule is immobilized on the conductive material surface of said flat surface for spotting, as well as comprises a terminal capable of passing an electric current to said conductive material surface of the protruding spot part on the surface of said substrate in areas other than the protruding spot part. The surface of the substrate in areas other than the protruding spot part comprises a conductive material coating layer, and the terminal can be comprised in said conductive material coating layer or capable of passing an electric cOurrent to the conductive material coating layer. Furthermore, this conductive material coating layer and the conductive material surface of the protruding spot part are preferably provided as an integrated conductive material coating layer. The above-described substrates I and II are examples of such a substrate. The details are as described above. Biomolecules are immobilized on the substrate of the second aspect in the same manner as described for the first aspect above.

In the method of causing interaction between biomolecules of the second aspect, an electrode (opposite electrode) is positioned so as to face the substrate surface on which the biomolecules have been immobilized. In this method, a voltage is applied between the conductive material surface of the substrate and the opposite electrode to generate an electric field, thereby causing the target biomolecules contained in the solution positioned between the substrate and the opposite electrode to selectively migrate toward the substrate and concentrate in the vicinity of the substrate surface. This concentration of the target biomolecules in the vicinity of the substrate surface can promote interaction between the biomolecules immobilized on the substrate and the target biomolecules.

The above opposite electrode is not specifically limited other than that it be capable of generating an electric field between the biomolecule microarray and the opposite electrode. The entire opposite electrode may be comprised of gold, nickel, platinum, silver, titanium, aluminum, stainless steel, copper, chromium, a conductive oxide, or a conductive plastic. Alternatively, the opposite electrode may be one having a conductive material coating layer comprised of metal, nickel, platinum, silver, titanium, aluminum, stainless steel, copper, chromium, a conductive oxide, or a conductive plastic on the surface facing the conductive material surface of the substrate. In the present invention, when the opposite electrode is a transparent electrode of ITO (indium tin oxide), tin oxide, or the like, the interaction between biomolecules can be detected in real time with a fluorescence detector or the like from above the transparent electrode simultaneously with interaction between the biomolecules. When the substrate included in the biomolecule microarray is comprised of optically transparent glass or plastic upon which is provided a transparent conductive coating layer, or when the entire substrate is comprised of a transparent, conductive material, it is similarly possible to detect the interaction in real time.

In the above method, a voltage is applied at a frequency of 0.01 to 10 Hz between the conductive material surface and the opposite electrode. The application of such a voltage to generate an electric field between the conductive material surface and the opposite electrode can cause the target biomolecules in the solution to selectively migrate toward the substrate and concentrate, thereby increasing the efficiency of the reaction and promoting interaction between biomolecules.

In the above method, the frequency of the voltage applied between the conductive material surface of the substrate and the opposite electrode is 0.01 to 10 Hz. When the frequency is less than 0.01 Hz, the level of concentration of the target biomolecules in the vicinity of the substrate surface within a prescribed period of time decreases and the effect of the promoting interaction diminishes. Further, when the frequency exceeds 10 Hz, there is a risk of the solution containing the target biomolecules being electrolyzed, generating bubbles. The frequency is desirably 0.01 to 1 Hz.

The voltage applied between the conductive material surface of the substrate and the opposite electrode is desirably 0.1 to 4 V. When the voltage falls within this range, there are no problems with electrolysis and heat generation, and interaction of the biomolecules can be promoted. The voltage is desirably 1 to 3 V.

The solution containing the target biomolecules desirably contains cations for the following reasons.

When the biomolecules in the solution are caused to selectively migrate unidirectionally through dielectrophoresis by application of a high-frequency alternating current voltage and cations are contained in the solution, the cations are preferentially moved by the application of the voltage and the biomolecules do not move.

By contrast, the present inventors discovered that by applying a voltage at a frequency of 0.01 to 10 Hz between the conductive material surface of the substrate and the opposite electrode to generate an electrical field, even when the solution contained cations, the target biomolecules could be caused to selectively migrate toward the substrate and concentrate, increasing the reaction efficiency of the interaction. The target biomolecules are thought to migrate in the solution by means of, so-called electroosmotic flow (EOF) when cations are contained in the solution in this manner. That is, it is thought that when cations are contained in the solution, the cations in the solution migrate when a voltage is applied, and the movement of the cations produces a flow in the solution that causes the target biomolecules to move, thereby selectively causing the target biomolecules to migrate toward the substrate.

Further, for example, to promote interaction between biomolecules when employing nucleic acid as the biomolecule, that is, to increase the efficiency of hybridization between the target nucleic acid and the probe nucleic acid, it is desirable for cations to be contained in the hybridization solution. This is because the positive charge of the cations cancels out the negative charge of the phosphoryl groups of the nucleic acid, heightening reactivity between the probe nucleic acid and the target nucleic acid. Thus, by adding cations to the target nucleic acid solution, it is possible to enhance the hybridization promoting effect by applying a voltage, thereby further increasing the efficiency of hybridization through the effects of the cations.

The voltage used in the above method is not specifically limited; sine wave alternating current voltage, rectangular wave alternating current voltage, standing wave direct current voltage, pulsed direct current voltage, and the like may be employed. A pulsed direct current voltage is desirably employed as a direct current voltage. When a pulsed direct current voltage is employed, target biomolecules can be made to move cyclically in a manner matching the cycle of the voltage, efficiently promoting interaction between the biomolecules. The voltage is desirably applied in a manner comprising a voltage application period during which at least the substrate surface is negatively charged. When a direct current voltage is employed, the application of an electrical field that negatively charges the substrate side is desirable. Since cations in the solution are drawn to the substrate side, the movement of the cations can be used to produce a solution current that selectively causes the target biomolecules to move to the substrate side.

In the above method, during the period when no voltage is being applied between the conductive material surface and the opposite electrode, the solution containing the target biomolecules is desirably subjected to a stirring operation. For example, when employing a pulsed direct current voltage, the solution can be stirred between voltage application cycles (when no voltage is being applied). By stirring the solution while no voltage is being applied in this manner, cations that have been made to migrate toward the substrate by the application of voltage can be dispersed in the solution. Subsequently, when the next voltage application is conducted, as the cations that have dispersed in the solution move about, the target biomolecules can be selectively made to migrate to the substrate side. In this manner, by repeatedly applying a voltage and stirring the solution, the target biomolecules can be sequentially made to migrate to the substrate side and efficiently concentrated in the vicinity of the substrate surface.

For example, the method of rotating the entire reaction vessel in a rotary oven or the method of providing a solution inlet linked to the interior of the chamber, linking the solution inlet with a tube to a pump such as a peristaltic or rotary pump, and stirring the solution within the chamber in reciprocating fashion may be employed as the method of stirring the solution.

The cations may be one or more selected from the group consisting of: sodium ions, potassium ions, lithium ions, magnesium ions, calcium ions, and aluminum ions. Of these cations, sodium ions and magnesium ions are preferred.

The cation concentration in the solution is desirably set to a concentration suited to interaction taking into account the type and frequency of the voltage being applied and the like. By way of example, a cation concentration of 1 to 1,000 mM, preferably 10 to 500 mM, may be employed.

The solution containing the target biomolecules may contain a buffer. A buffer with buffering ability in the neutral pH range is desirably employed, but this is not a limitation. Tris-HCl buffer is an example of a buffer that is suitable for use.

The temperature of the solution containing the target biomolecules is desirably suited to interaction. By way of example, a temperature from ordinary temperature (about 20° C., for example) to 70° C. may be employed. A temperature control means, such as a heater, may be employed to control the temperature of the solution containing the target biomolecules. When an excessively high voltage is employed, the generation of heat raises the temperature of the solution. Thus, it is sometimes necessary to strictly control the temperature. By contrast, since an interaction promoting effect can achieved with a relatively low voltage by the method of the first aspect, it affords the advantage of permitting implementation without using a strict temperature control means.

A spacer comprised of a nonconductive material can be sandwiched between the substrate and opposite electrode in a manner not covering the area where biomolecules have been immobilized. When a nonconductive spacer is positioned between the substrate and opposite electrode in this manner, the space enclosed by the substrate, opposite electrode, and nonconductive spacer can be filled with solution containing target biomolecules. Examples of the nonconductive material are silicon, rubber, glass, and plastic. In the present invention, the distance between the substrate and the opposite electrode can be set by the thickness of the spacer. The distance between the substrate and the opposite electrode can be suitably set within a range yielding a promoting effect on interaction between biomolecules with the application of an electric field. For example, a distance from 30 to 500 micrometers can be employed.

The nonconductive spacer may have adhesive layers on both surfaces thereof. These adhesive layers may be employed to adhere the nonconductive spacer to the substrate and the opposite electrode. The adhesive of the adhesive layers desirably contains a photosetting resin. Since photosetting resins set and lose their adhesive strength when irradiated with light, incorporating a photosetting resin into the photosetting adhesive makes it possible to remove the substrate and the opposite electrode from nonconductive spacer by irradiation with light. A known photosetting resin such as a UV-curing resin may be employed as the photosetting resin.

When the opposite electrode is transparent, the interaction can be detected in real time through the opposite electrode. Further, as set forth above, when the substrate included in the microarray is comprised of optically transparent glass or plastic upon which is provided a transparent conductive coating layer, or when the entire substrate is comprised of a transparent, conductive material, it is possible to conduct real time detection from the substrate side. The interaction may be detected by a method such as the use of a fluorescence detector, confocal detector, confocal laser fluorescence microscope, or fluorescence microscope. To detect interaction between biomolecules with a fluorescence detector, the target biomolecules are desirably labeled with a fluorochrome. The target biomolecules can be labeled with a fluorochrome by known methods. In the present invention, the biomolecules that are immobilized on the substrate surface may also be labeled with a fluorochrome. Known methods can be used to label the biomolecules immobilized on the substrate with a fluorochrome.

Further, as stated above, when a substrate having a protruding spot part is employed, interaction between biomolecules can be detected by a confocal detector. The principle for detection of reflected light and fluorescence with a confocal detector is as set forth above. When employing a substrate having a protruding spot part, automatic gridding is possible by specifying the size and position of spots from a reflected image based on the above-described principle using a confocal detector. The details are as set forth above.

In the present invention, it is particularly desirable to employ a confocal fluorescence scanner capable of simultaneously detecting both reflected light and fluorescence. The details are as set forth above.

The second aspect of the present invention further relates to a method of causing migration of a biomolecule comprised in a solution placed between a substrate on at least a portion of which a conductive material surface is comprised and an electrode (opposite electrode) facing said conductive material surface, characterized by applying a voltage at a frequency ranging from 0.01 to 10 Hz between said conductive material surface and said opposite electrode to cause said biomolecule to migrate toward either said substrate or said opposite electrode.

The details of the substrate, opposite electrode, biomolecules, electric field applied, and the like employed in this method are as set forth above for the method of causing interaction between biomolecules above.

The above-mentioned method of causing migration of biomolecule can be used to selectively cause biomolecules to migrate toward the substrate and concentrate in the vicinity of the substrate surface, or to selectively cause biomolecules to migrate toward the opposite electrode and concentrate in the vicinity of the surface of the opposite electrode.

The above method of causing the migration of biomolecule can be used to sequence nucleic acid. For example, when interaction between biomolecules is caused with the above method of causing interaction between biomolecules, target nucleic acid fully complementary with the probe nucleic acid interacts forcefully with the probe nucleic acid. By contrast, target nucleic acid having a partial sequence mismatch with the probe nucleic acid interacts weekly with the probe nucleic acid. Thus, when a reverse electrical field is applied, such target nucleic acid separates from the probe nucleic acid, migrating toward the opposite electrode. In this manner, differences in base sequence from the fully complementary sequence, such as single nucleotide polymorphism (SNP), can be detected by the above-described method of causing migration of biomolecule.

### EXAMPLES

The present invention will be described in greater detail below through Examples.

### The first aspect

### Example 1

### Dielectric Hybridization

### (1) Preparation of a Microarray Having Protruding Spot Parts

### (i) Preparation of Array Part

A metal mold having indentations corresponding to protruding spot parts to be formed on a substrate was prepared by photolithographic and micromilling techniques. This metal mold was employed to manufacture a polycarbonate array part by injection molding. Each of the protruding spot parts was 200 micrometers in height with a square flat surface for spotting measuring 90 micrometers on a side. The angle between the flat surface for spotting and the lateral surface of the protruding spot parts was 95 degrees. FIG. 13 is a sectional view of one of the protruding spot parts.

The array part thus prepared was set in the bell jar of a vacuum deposition device (model KS-807RK, made by K-Science, Inc.). A vacuum of 10×10⁴ Pa or less was generated within the bell jar and chromium was vapor deposited at a rate of 0.08 nm/s to a thickness of 50 nm, followed by gold at a rate of 0.5 nm/s to a thickness of 500 nm.

The array part shown in FIG. 8 was prepared by the above method.

### (ii) DNA Stamping

A 45-mer oligo DNA probe solution (120 microM in 1× microspotting solution (TeleChem International)+0.1% Tween 20) was spotted on the flat surface for spotting on the tops of the protruding spot parts of the array part with a DNA arrayer. A stamping needle with a round tip 130 micrometers in diameter was employed.

Probe DNA in the form of 45-mer oligo DNA having the following 11 gene sequences was employed.

[Formula 1]
beta-actin,
TTTTGTCCCCCCAACTTGATGTATGAAGGCTTTGGTCTCCCTGGG
NF-L,
GGCCGTTCTGCTTACAGTGGCTTGCAGAGCAGCTCCTACTTGATG
Ubiquitin 2e,
GTACCAACATTGCCTCCTAGCAGAGAAGTGTGTGTGTGAGAAGCC
hsc70,
CCTATGGTGCAGCTGTCCAGGCAGCCATTCTATCTGGAGACAAGT
rpL3,
GGTGAGGTGACCAATGACTTCATCATGCTCAAAGGCTGTGTGGTG
Akt,
GCTGGACAAGGACGGGCACATCAAGATAACGGACTTCGGGCTGTG
Transthyretin,
ACCATCGCAGCCCTGCTCAGCCCATACTCCTACAGCACCACGGCT
rpS5,
CATTGCTGTGAAGGAGAAGTATGCCAAGTACCTGCCCCACAGTGC
HCN1,
GTGCCACAGCGTGTCACCTTGTTCAGACAGATGTCCTCGGGAGCC
GAPDH,
GCAGTGGCAAAGTGGAGATTGTTGCCATCAACGACCCCTTCATTG
Lhb1B2,
ACTCAAGTTATCCTCATGGGAGCTGTTGAAGGCTACAGAGTCGCC

### (2) Preparation of Nonconductive Spacer

A 90 micrometer PEN sheet having adhesive layers (the adhesive layers being covered with peel-off sheets) containing UV-curing resin on both sides was die cut with a Thompson die to prepare the nonconductive spacer shown in FIG. 9.

(3) Preparation of Opposite Electrode

ITO glass was cut to prescribed dimensions to prepare an opposite electrode.

### (4) Preparation of Cover Part

A polycarbonate cover part was prepared by injection molding. FIG. 10 shows a schematic diagram of the cover part. An indented portion (opposite electrode insertion portion) for insertion of the opposite electrode and a hollow portion (observation window) for observing the interior of the cavity through the opposite electrode were provided in the cover part. A conductive stuff (in the form of a silver-plated copper stuff) was inserted into the cover part.

### (5) Assembly of the Device of Testing Interaction Between Biomolecules

The peel-off sheet was removed from one side of the nonconductive spacer and the array part and the nonconductive spacer were adhered so that the spots with immobilized biomolecules and two through-holes for introducing solution provided on the array part were located in the hole of the nonconductive spacer and two conducting through-holes in the array part lined up with two through-holes provided in the nonconductive spacer. The opposite electrode was inserted into the opposite electrode insertion portion of the cover part. The other peel-off sheet of the nonconductive spacer was removed and the cover part and the nonconductive spacer were adhered to prepare the device shown in FIG. 1. In this device, there was a 30 micrometer gap between the surface of the opposite electrode and the surface upon which the DNA had been immobilized.

### (6) Dielectric Hybridization

Cy3-labeled cDNA obtained by labeling mouse brain-derived mRNA with a Cyscribe cDNA post labeling kit made by Amersham was employed as the target DNA. Hybridization solutions in the form of 50 mM L-histidine solutions of the mouse brain-derived Cy3-labeled cDNA target prepared to concentrations of 5 ng/microliters, 0.5 ng/microliters, and 0.05 ng/microliters were employed. The hybridization solutions were thermally denatured for two minutes at 95° C., rapidly cooled for two minutes at 4° C., and then employed in hybridization. Hybridization was conducted under conditions where a 1 MHz 30 Vp-p high frequency alternating current electric field was applied and where it was not applied. The results are given in FIG. 11. As will be understood from FIG. 11, a more than ten-fold improvement in detection sensitivity was observed when an electric field was applied relative to when the electric field was not applied.

### Example 2

### Measurement of Melting Temperature and Detection of SNP

PM (fully complementary 20-mer, sequence: GGACATGGAGTTCCGCGACC) and MM (20-mer with a single base in the middle differing from PM, sequence: GGACATGGAGATCCGCGACC) DNA probes were stamped and immobilized on the microarray prepared in Example 1.

A 21-mer (sequence: GGTCGCGGAACTCCATGTCC) complementary strand to the PM that had been labeled with Cy3 on the 5′ end was employed as target DNA.

The hybridization solution employed was 0.5 microM target DNA, 50 mM histidine.

Hybridization was conducted for 10 minutes at room temperature while applying a 1 MHz, 30 Vp-p (1 MV/m) alternating current electric field. Subsequently, 2×SSC/0.1% SDS cleaning solution was introduced through the solution inlet provided in the microarray and washing was conducted three times. With the cleaning solution still in the cavity, hybrid signal was detected in real time through the opposite electrode via the observation window provided in the cover part while heating the solution in the cavity from room temperature to 68° C. under a fluorescence microscope, and a DNA hybrid melting curve was determined. This melting curve is shown in FIG. 12. The melting temperature is the temperature at which 50 percent of the double-stranded DNA dissociated. The melting temperature of the PM obtained from the melting curve shown in FIG. 12 was about 61° C. and that of MM was about 59° C.; there was a difference in melting temperature between PM and MM of about 2° C. Using this difference in melting temperature, it is possible to detect mutation such as single nucleotide polymorphism.

### Second Aspect

### Example 3

### Relation Between Frequency of Voltage Applied and Concentration of Nucleic Acid

A piece of double-adhesive film the center of which had been cut out to allow the introduction of a nucleic acid solution was adhered to the substrate surface of a DNA microarray substrate the surface of which had been coated with gold. An ITO electrode was adhered thereover so that the electrode surface faced the substrate. The portion into which the solution was entered was fashioned into a chamber in a manner permitting the introduction of solution through a portion of the adhesive film. FIG. 14 is a schematic of the device. The nucleic acid solution with which the chamber of the device shown in FIG. 14 was filled was 0.1 microM Cy3-labeled oligo DNA (45-mer), 40 mM Tris-HCl (pH 8.3), 4 mM EDTA, and 400 mM NaCl. The above chamber was filled with this nucleic acid solution, the substrate surface and the ITO electrode were connected to the terminals of the poles of an alternating current voltage generator, and a sine wave alternating current voltage was applied while varying the frequency from 10 Hz to 0.01 Hz at a voltage of 3 Vp-p. In the graph of FIG. 15, the arrows indicate points where the various frequencies were applied or where the frequencies were changed. The curve of the graph shows the quantity of nucleic acid molecules in the vicinity of the surface of the array as the intensity of the fluorescence of fluorescence labeling as measured by confocal laser fluorescence microscopy. The greater the intensity of the fluorescence, the more concentrated the nucleic acid molecules in the vicinity of the array surface. An increase in the fluorescence intensity matching the cycle of the voltage being applied, that is, a concentration of nucleic acid, was observed under these conditions, particularly for frequencies of 0.1 Hz and 0.01 Hz.

### Example 4

### Relation Between Waveform of Voltage Applied and Nucleic Acid Concentration

Using the same device as in Example 3, voltage was applied in a waveform pattern that was either a sine wave or a rectangular wave and the relation between the voltage curve and the concentration of nucleic acid was examined. As in Example 3, 0.1 microM Cy3-labeled oligo DNA (45-mer), 40 mM Tris-HCl (pH 8.3), 4 mM EDTA, and 400 mM NaCl was employed as the nucleic acid solution. The voltage was 3 Vp-p, applied as either sine wave or rectangular wave alternating current voltage. The results are given in FIG. 16. As is shown in FIG. 16, an increase in fluorescence intensity corresponding to the voltage waveform was observed for both of these waveforms. Thus, it was determined that the application of voltage permitted the efficient concentration of nucleic acid in the vicinity of the substrate surface and, irrespective of the waveform, nucleic acid accumulated and concentrated in the vicinity of the substrate surface when the substrate surface was negatively charged.

### Example 5

### Concentration of Nucleic Acid by Pulsed Direct Current Voltage

Using the same device as in Example 3, a pulsed direct current voltage was applied in such a manner that the array surface was negatively charged. The nucleic acid solution employed was identical to that in Example 3. A −2 V voltage was applied at a cycle of 0.1 Hz for one second at a time. The results are given in FIG. 17. As is shown in FIG. 17, an increase in fluorescence intensity matching the cycle of the voltage was observed. This confirmed that the application of a pulsed direct current voltage concentrated the nucleic acid in a manner matching the voltage cycle. These results also showed that the application of a negative charge to the array surface resulted in concentration of the target nucleic acid. A voltage of −2 V was then applied at cycles of 0.1 Hz (1 s application), 1 Hz (0.1 s application), and 10 Hz (0.01 s application) and concentration of the nucleic acid was observed. As a results shown in FIG. 18, in all cases, the fluorescence intensity increased in a manner matching the voltage cycle (in FIG. 18, the arrows mark voltage application starting points). This confirmed that the application of voltage caused the nucleic acid to migrate toward the negatively charged substrate, concentrating in the vicinity of the substrate surface. The fluorescence intensity was greatest at a frequency of 0.1 Hz. As the frequency increased, the fluorescence intensity diminished. Thus, under these conditions, it was found that the nucleic acid concentrating effect was the most pronounced at a frequency of 0.1 Hz.

### Example 6

### Promoting Hybridization by Applying Pulsed Direct Current Voltage

The DNA microarray substrate employed in Example 3 was stamped with 10 spots each of two probe DNAs (GAPDH and beta-actin) of equal concentration. Following stamping, the substrate was irradiated with 600 mJ/cm² of UV, washed twice with MQW for 5 minutes, and then dried. Probe DNA that had been modified with array-use linker (made by Nisshinbo Industries, Inc.) on the 5′ end was employed. Hereinafter, spots stamped with GAPDH-derived probe DNA will be referred to as GAPDH spots and spots stamped with beta-actin-derived probe DNA will be referred to as beta-actin spots.

Target DNA solution in the form of 5′ terminal Cy3 fluorescence-labeled oligo DNA (a sequence complimentary with GAPDH; solution: 40 mM Tris-HCl (pH 8.3), 4 mM EDTA, and 400 mM NaCl) with a concentration of 0.01 microM was employed. Hybridization was conducted with the same device and under the same voltage application conditions as in Example 5. For comparison, hybridization was also conducted under conditions where no voltage was applied. FIG. 19 gives the results of measurement in real time by confocal laser fluorescence microscope of the change in fluorescence intensity on spots in the course of the hybridization reaction. At GAPDH spots containing probe DNA having a sequence complementary with the target DNA, when a voltage was applied, there was a sharp increase in fluorescence intensity relative to when no voltage was applied, and the speed of the hybridization reaction was accelerated 20-fold or greater. By contrast, at beta-actin spots not containing DNA having a sequence complementary with the target DNA, no increase in fluorescence intensity was observed over time. This indicates that nonspecific adsorption did not occur at beta-actin spots even when a voltage was applied. After conducting a hybridization reaction for 10 minutes, sequentially washing was conducted with 2×SSC+0.1% Tween 20, 1×SSC, and 0.2×SSC. Subsequently, an image was taken by microarray scanner (FIG. 20). For comparison, hybridization was conducted for 16 hours without the application of voltage and an image was similarly taken by scanner. As a result, when the reaction was conducted for 10 minutes, the case where a voltage was applied exhibited an increase in fluorescence intensity of about 13-fold relative to the case where no voltage was applied. This showed that the application of a voltage greatly increased the sensitivity of the hybridization reaction. Further, after reacting for 10 minutes with the application of voltage, an increase in fluorescence intensity of about six-fold relative to when the reaction was conducted for 16 hours without the application of a voltage was observed. Thus, the method of the present invention greatly increased both the speed and sensitivity of the hybridization reaction.

The sequences of the two probe DNAs employed in Example 6 are given below.

TABLE 1

| | |
|---|---|
| beta- | 5′ -TTTTGTCCCCCCAACTTGATGTATGAAGGCTTTGGTCTCCCTGGG-3′ |
| actin | |
| GAPDH | 5′ -GCAGTGGCAAAGTGGAGATTGTTGCCATCAACGACCCCTTCATTG-3′ |

### Example 7

### Concentration of Protein Molecules by Application of Low-Frequency Alternating Current Voltage

Using the same device as in Example 3, the concentration of protein molecules by the application of a low-frequency, alternating current voltage was examined. The protein molecule solution employed was 1 microM Cy3-labeled streptoavidin, 40 mM Tris-HCl (pH 8.3), 4 mM EDTA, and 400 mM NaCl. A 3 Vp-p, 0.1 Hz alternating current voltage was applied. The results are given in FIG. 21. As shown in FIG. 21, even when protein molecules were employed as the biomolecules, an increase in fluorescence intensity was exhibited based on the voltage waveform, and concentration of protein molecules in the vicinity of the substrate surface by the application of voltage was confirmed. Even in the present example, the migration and concentration of protein molecules was observed when the substrate was negatively charged.

### INDUSTRIAL APPLICABILITY

The first aspect of the present invention permits the testing in real time of the interaction between biomolecules while promoting the interaction between biomolecules. Further, the present invention permits the measurement of the melting temperature of biomolecules, and the ready and rapid detection of mutation such as single nucleotide polymorphism.

The second aspect of the present invention can greatly increase the speed and sensitivity of the interaction between biomolecules.

### BRIEF DESCRIPTION OF THE DRAWINGS

FIG. 1 shows a schematic of the device of the present invention.

FIG. 2 shows a schematic showing the optical system of a confocal detector.

FIG. 3 shows an example of the substrate employed in the present invention.

FIG. 4 shows a schematic of a protruding spot part on a substrate.

FIG. 5 shows an enlarged view of a portion of a substrate having a roughly V-shaped bottom surface.

FIG. 6 shows an example (partially enlarged view) of a flat surface for spotting that has been roughened.

FIG. 7 shows a schematic of the optical system of a confocal fluorescence scanner capable of simultaneously detecting reflected light and fluorescence.

FIG. 8 shows a schematic of the array part prepared in Example 1.

FIG. 9 shows a schematic of the nonconductive spacer prepared in Example 1.

FIG. 10 shows a schematic of the cover part prepared in Example.

FIG. 11 shows the results obtained in Example 1 (a scatter diagram of hybridization intensity for dielectric hybridization and nondielectric hybridization)

FIG. 12 shows the melting curve obtained in Example 2.

FIG. 13 shows a sectional view of a protruding spot part on the array part prepared in Example 1.

FIG. 14 shows a schematic of the device employed in Example 3.

FIG. 15 shows the results obtained in Example 3 (the relation between the frequency of the voltage applied and the concentration of nucleic acid)

FIG. 16 shows the results obtained in Example 4 (the relation between the waveform of the voltage applied and the concentration of nucleic acid)

FIG. 17 shows the results obtained in Example 5.

FIG. 18 shows the results obtained in Example 5.

FIG. 19 shows the results obtained in Example 6.

FIG. 20 shows an image taken by microarray scanner obtained in Example 6.

FIG. 21 shows the results obtained in Example 7.

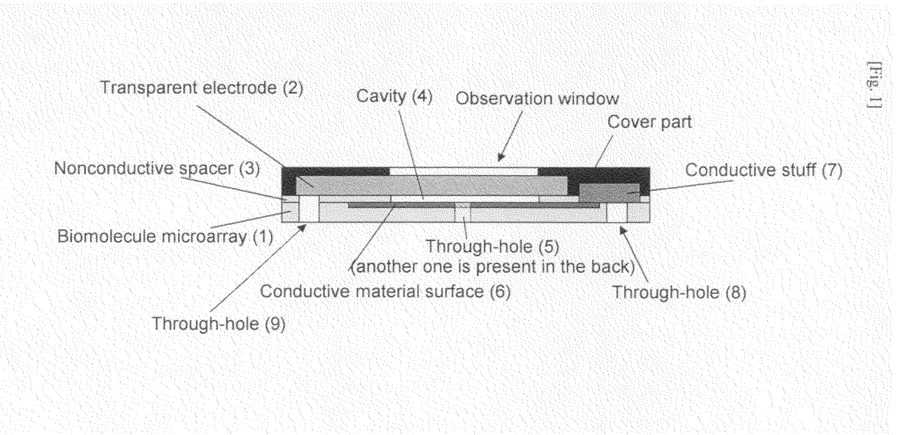

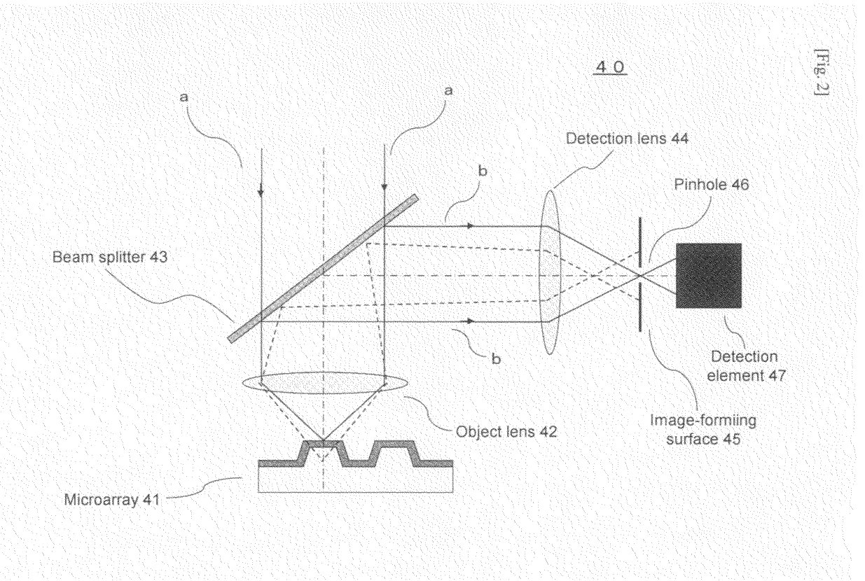

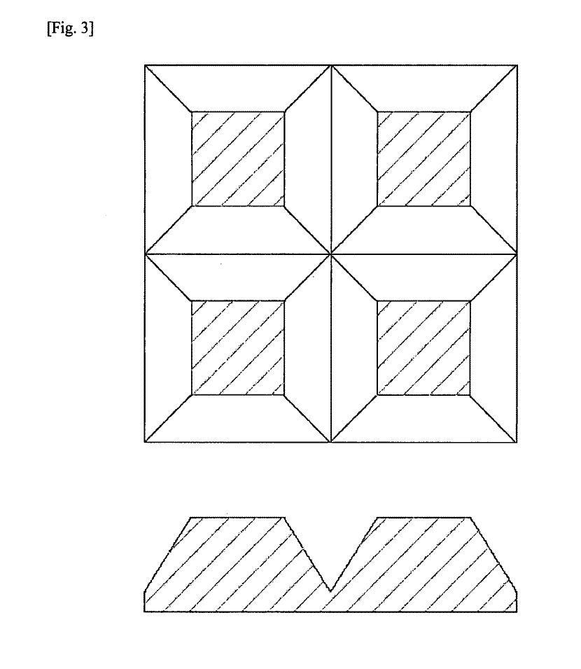

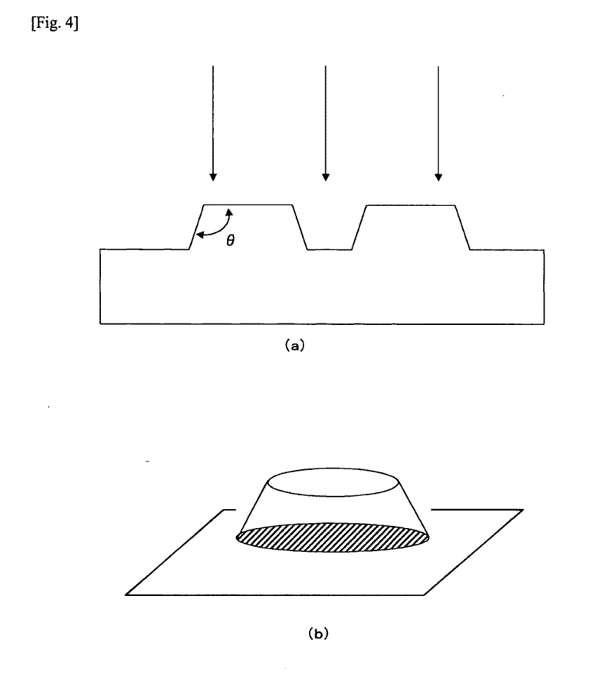

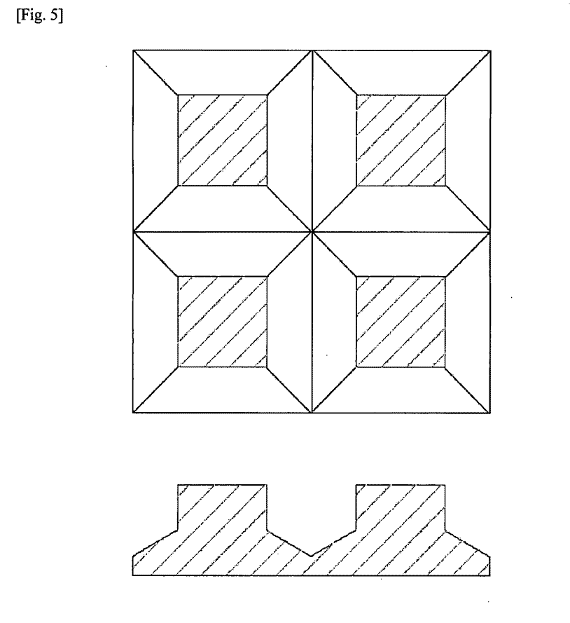

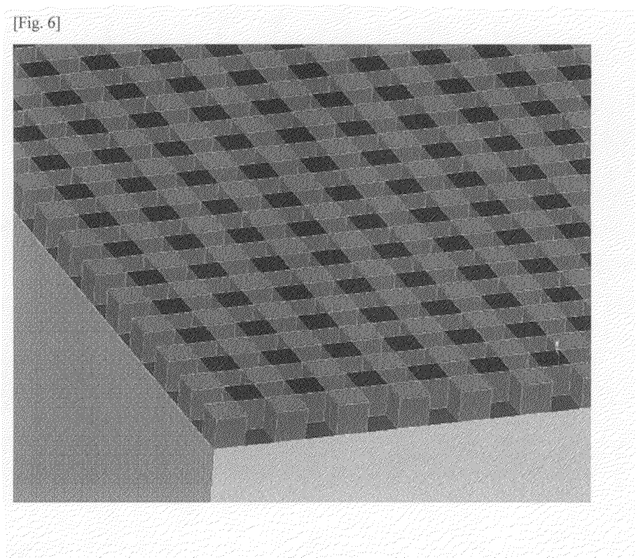

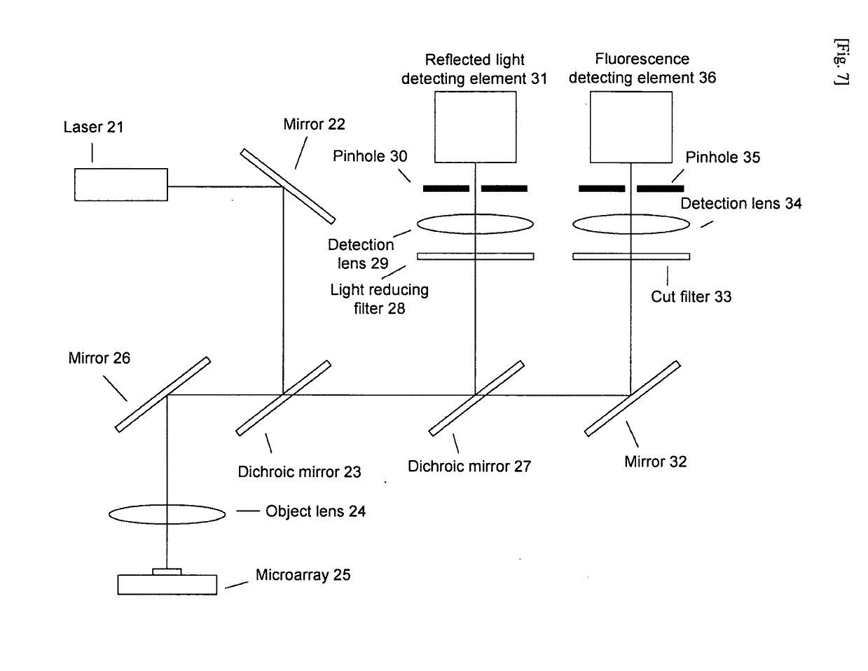

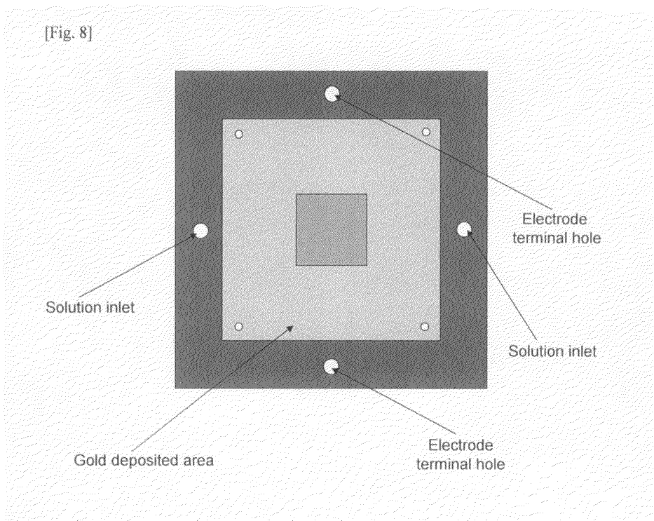

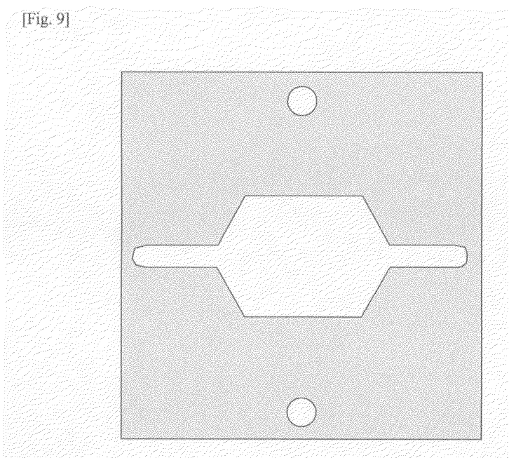

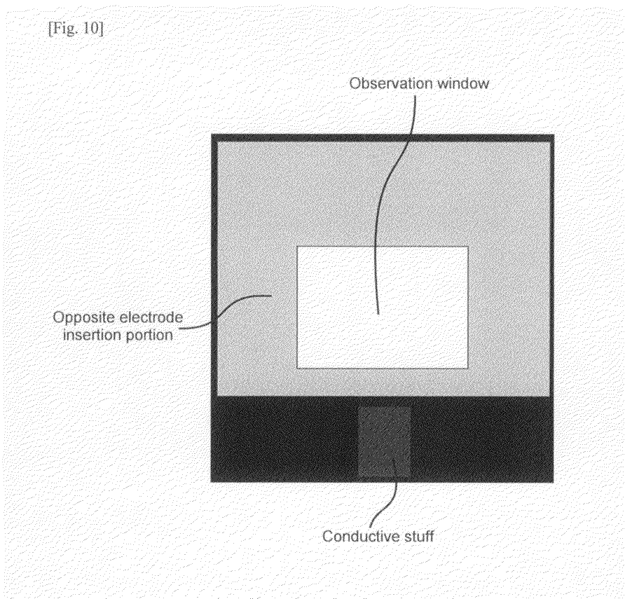

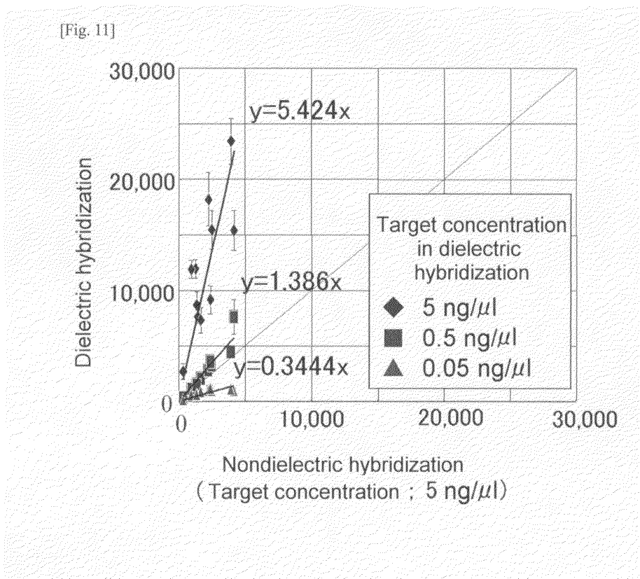

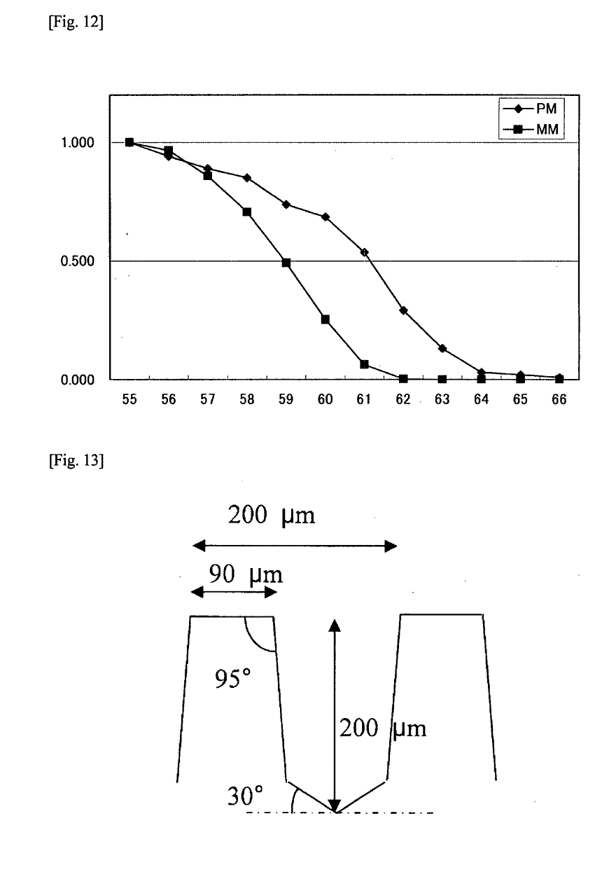

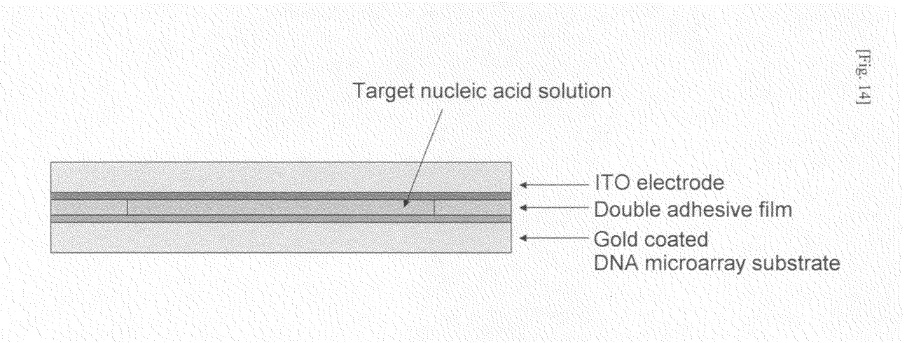

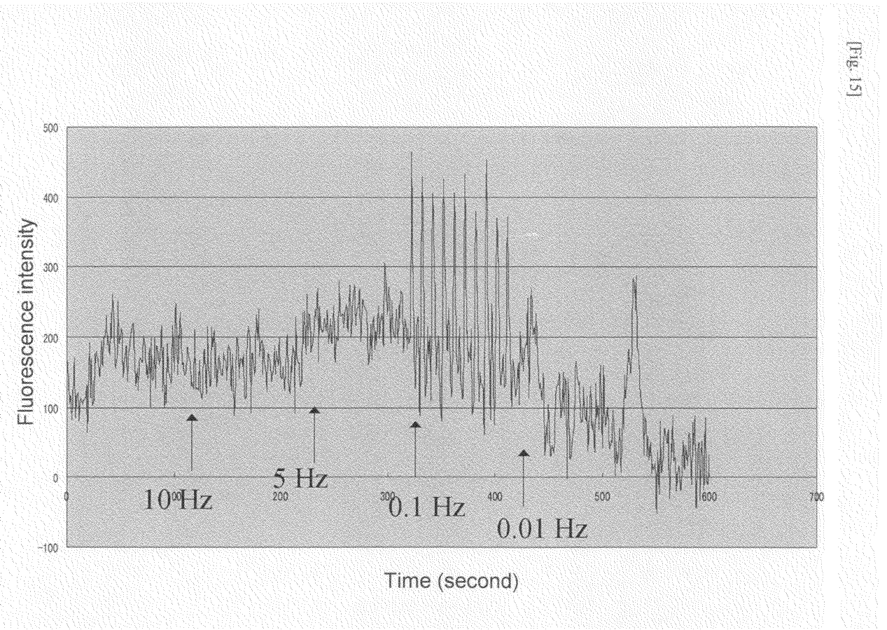

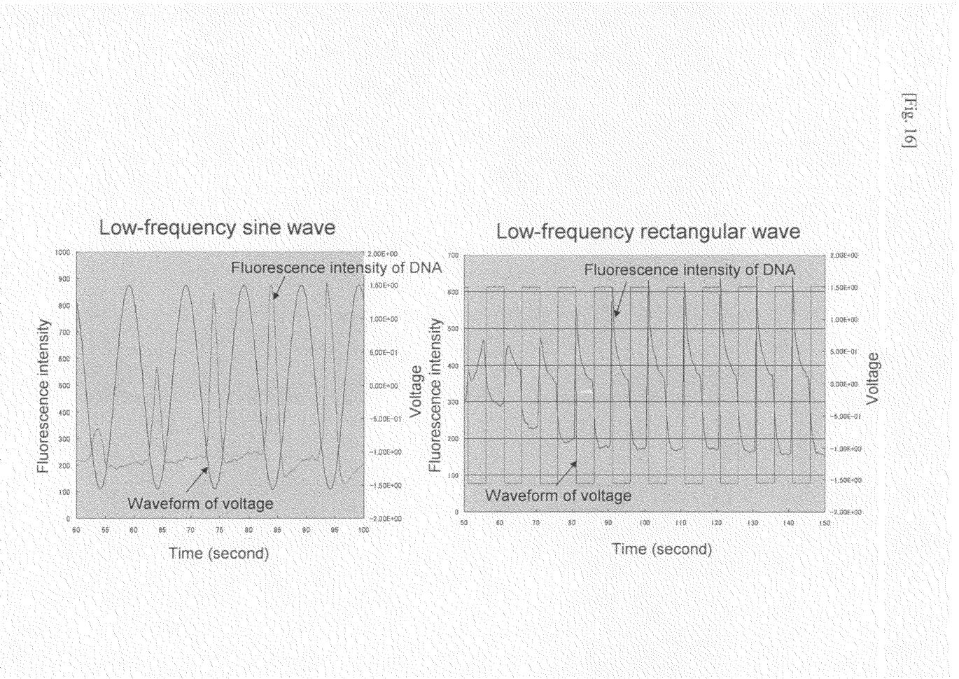

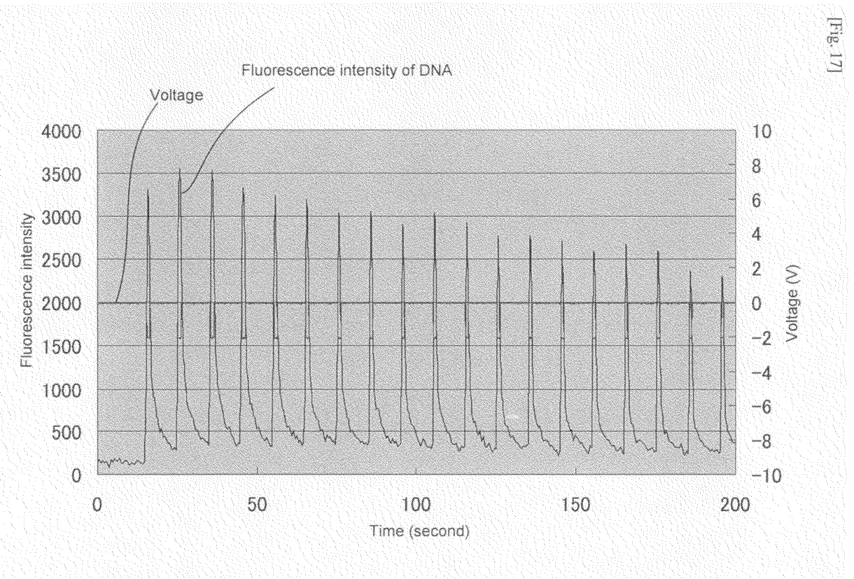

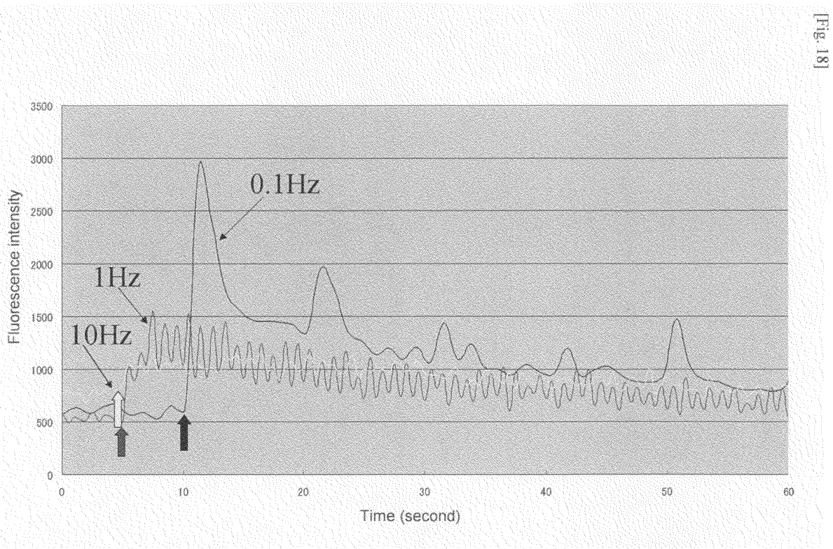

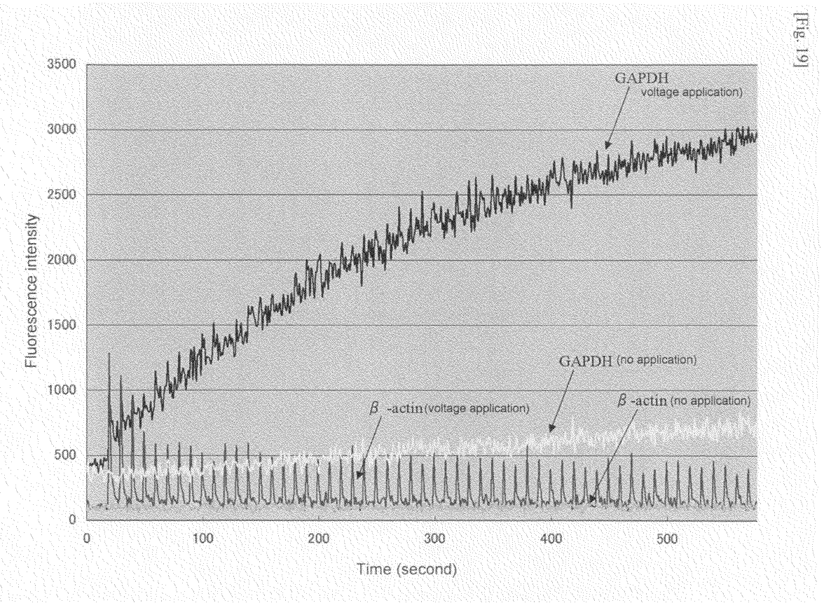

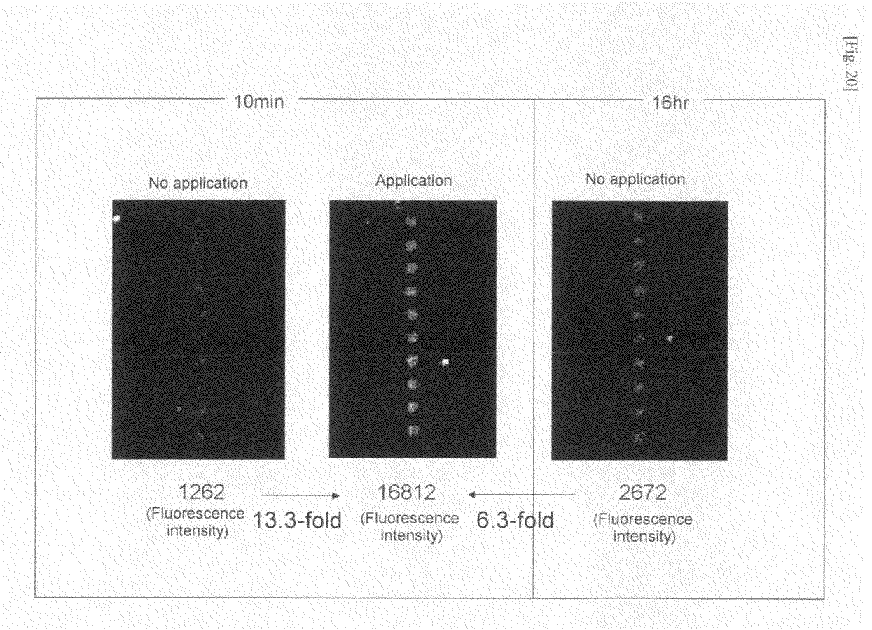

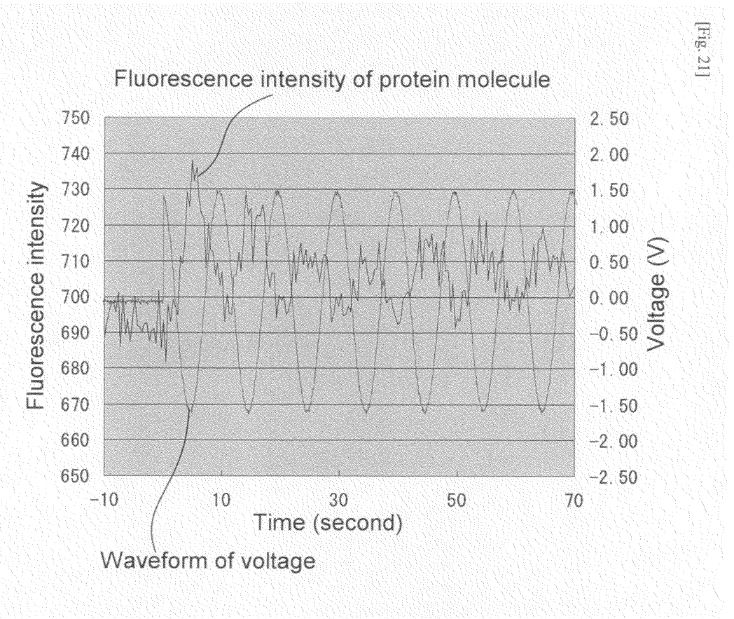

1. A device of testing interaction between biomolecules comprising a biomolecule microarray (1) in which a biomolecule is immobilized on a substrate and a transparent electrode (2) positioned so as to face the surface of the substrate of said microarray on which the biomolecule is immobilized, which electrode is hereinafter referred to as “opposite electrode”, wherein
said device comprises a nonconductive spacer between said microarray (1) and said opposite electrode (2), and a cavity (4) is formed by said microarray (1), said spacer (3) and said opposite electrode (2),
said microarray (1) comprises a conductive material surface (6) on at least a portion of the surface on which the biomolecule is immobilized, as well as comprises two through-holes (5) communicating with said cavity (4), one of which is a hole for introducing a solution into the cavity, and the other of which is a hole for discharging a solution from the cavity.

2. The device according to claim 1, which comprises a means for connecting the conductive material surface (6) on said microarray (1) and the opposite electrode (2) to an external power source from the side of said microarray (1).

3. The device according to claim 2, which further comprises a conductive stuff (7) at least a portion of which contacts the conductive material surface (6) of said microarray (1) and does not contact said opposite electrode (2), and the conductive material surface (6) on said substrate is connected through said conductive stuff (7) to the external power source.

4. The device according to claim 3, wherein the conductive material included in said conductive stuff (7) is gold, nickel, platinum, silver, titanium, aluminum, stainless steel, copper, conductive oxide, or conductive plastic.

5. The device according to claim 3, wherein said microarray comprises a through-hole (8) communicating with said conductive stuff (7) and a through-hole (9) communicating with said opposite electrode (2).

6. The device according to claim 1, wherein said nonconductive spacer (3) is positioned so as to make an interval between said microarray (1) and said opposite electrode (2) uniform.

7. The device according to claim 1, wherein the distance between the surface of said microarray (1) on which the biomolecule is immobilized and the surface of said opposite electrode (2) which faces the surface of said microarray (1) on which the biomolecule is immobilized ranges from 10 to 30 micrometers.

8. The device according to claim 1, wherein the conductive material included in the conductive material surface on said microarray is gold, nickel, platinum, silver, titanium, aluminum, stainless steel, copper, chromium, conductive oxide, or conductive plastic.

9. The device according to claim 1, wherein the whole of said substrate consists of a conductive material or said substrate comprises a conductive material coating layer on the surface of the substrate.

10. The device according to claim 9, wherein said substrate comprising a conductive material coating layer consists of glass, quartz, metal, silicon, or plastic.

11. The device according to claim 1, wherein said nonconductive spacer (3) comprises adhesive layers on both surfaces thereof.

12. The device according to claim 11, wherein said adhesive comprises a photosetting resin.

13. The device according to claim 1, which further comprises a temperature control means.

14. The device according to claim 1, wherein
said substrate comprises a spot for immobilizing a biomolecule which protrudes from the surface of the substrate and comprises a flat surface for spotting on the top thereof, which spot is hereinafter referred to as “protruding spot part”,
at least said protruding spot part comprises a conductive material surface,
a biomolecule is immobilized on the conductive material surface of said flat surface for spotting, and
said substrate comprises a terminal capable of passing an electric current to said conductive material surface of the protruding spot part on the surface of said substrate in areas other than the protruding spot part.

15. The device according to claim 14, wherein said surface of the substrate in areas other than the protruding spot part comprises a conductive material coating layer, said terminal is comprised in said conductive material coating layer or capable of passing an electric current to said conductive material coating layer.

16. The device according to claim 14, wherein said surface of the substrate in areas other than the protruding spot part comprises a conductive material coating layer, and said conductive material coating layer and the conductive material surface of the protruding spot part are provided as an integrated conductive material coating layer.

17. The device according to claim 14, wherein said substrate is a substrate in which at least the substrate surface around the protruding spot part, the lateral surface of the protruding spot part, and the flat surface for spotting are comprised of a conductive material.

18. The device according to claim 17, wherein said substrate surface around the protruding spot part forms a roughly V-shaped bottom surface.

19. The device according to claim 14, wherein said substrate is a substrate in which the protruding spot parts adjacent each other border through the lateral surface of the protruding spot part, and at least said lateral surface of the protruding spot part and the flat surface for spotting are comprised of a conductive material.

20. The device according to claim 14, wherein said protruding spot part has a height ranging from 10 to 500 micrometers.

21. The device according to claim 14, wherein the angle formed between said flat surface for spotting on the top of the protruding spot part and said lateral surface of the protruding spot part is equal to or greater than 90 degrees.

22. The device according to claim 14, wherein said spot for immobilizing a biomolecule is a roughened surface,

23. The device according to claim 1, wherein said biomolecule is at least one selected from the group consisting of DNA, RNA, PNA, protein, polypeptide, sugar compound, lipid, natural small molecule, and synthetic small molecule.

24. A method of testing interaction between biomolecules using a device comprising a biomolecule microarray (1) in which a biomolecule is immobilized on a substrate and a transparent electrode (2) positioned so as to face the surface of said microarray on which the biomolecule is immobilized, which electrode is hereinafter referred to as “opposite electrode”, as well as comprising a nonconductive spacer between said microarray (1) and said opposite electrode (2) in which a cavity (4) is formed by said microarray (1), said spacer (3) and said opposite electrode (2), wherein
said microarray (1) comprises a conductive material surface (6) on at least a portion of the surface on which the biomolecule is immobilized, as well as
said method comprises:
applying an electric field between said microarray (1) and said opposite electrode (2),
while introducing a solution comprising a target biomolecule and/or a solution not comprising a target biomolecule into said cavity (4), optically detecting through said opposite electrode interaction between said biomolecule on the microarray and said target biomolecule.

25. A method of testing interaction between biomolecules using a device comprising a biomolecule microarray (1) in which a biomolecule is immobilized on a substrate and a transparent electrode (2) positioned so as to face the surface of said microarray on which the biomolecule is immobilized, which electrode is hereinafter referred to as “opposite electrode”, as well as comprising a nonconductive spacer between said microarray (1) and said opposite electrode (2) in which a cavity (4) is formed by said microarray (1), said spacer (3) and said opposite electrode (2), wherein
said microarray (1) comprises a conductive material surface (6) on at least a portion of the surface on which the biomolecule is immobilized, as well as
said method comprises:
applying an electric field between said microarray (1) and said opposite electrode (2),
filling said cavity (4) with a solution comprising a target biomolecule, maintaining the
solution in the cavity for a prescribed period, and then discharging said solution, and
optically detecting through said opposite electrode interaction between said biomolecule on the microarray and said target biomolecule while said solution is being maintained or after said solution has been discharged.

26. The method according to claim 25, which comprises newly filling said cavity with a solution comprising a target biomolecule and/or a solution not comprising a target biomolecule after said solution has been discharged or while said solution is being discharged.

27. The method according to claim 24, wherein the conductive material surface (6) on said microarray (1) and the opposite electrode (2) are connected to an external power source from the side of said microarray (1) to apply an electric field between said microarray (1) and said opposite electrode (2).

28. The method according to claim 24, wherein said device is a device of testing interaction between biomolecules comprising a biomolecule microarray (1) in which a biomolecule is immobilized on a substrate and a transparent electrode (2) positioned so as to face the surface of the substrate of said microarray on which the biomolecule is immobilized, which electrode is hereinafter referred to as “opposite electrode”, wherein
said device comprises a nonconductive spacer between said microarray (1) and said opposite electrode (2), and a cavity (4) is formed by said microarray (1), said spacer (3) and said opposite electrode (2),
said microarray (1) comprises a conductive material surface (6) on at least a portion of the surface on which the biomolecule is immobilized, as well as comprises two through-holes (5) communicating with said cavity (4), one of which is a hole for introducing a solution into the cavity, and the other of which is a hole for discharging a solution from the cavity.

29. The method according to claim 28, wherein the solution is introduced into said cavity and/or the solution is discharged from said cavity through the through-hole (5) comprised in said microarray (1) and communicating with said cavity.

30. The method according to claim 24, wherein said device is a device of testing interaction between biomolecules comprising a biomolecule microarray (1) in which a biomolecule is immobilized on a substrate and a transparent electrode (2) positioned so as to face the surface of the substrate of said microarray on which the biomolecule is immobilized, which electrode is hereinafter referred to as “opposite electrode”, wherein
said device comprises a nonconductive spacer between said microarray (1) and said opposite electrode (2), and a cavity (4) is formed by said microarray (1), said spacer (3) and said opposite electrode (2),
said microarray (1) comprises a conductive material surface (6) on at least a portion of the surface on which the biomolecule is immobilized, as well as comprises two through-holes (5) communicating with said cavity (4), one of which is a hole for introducing a solution into the cavity, and the other of which is a hole for discharging a solution from the cavity, and said conductive stuff (7) and said opposite electrode (2) are connected to a terminal of the external power source through the through-hole (8) communicating with said conductive stuff (7) and the through-hole (9) communicating with said opposite electrode (2).

31. The method according to claim 31, wherein the solution is introduced into said cavity and/or the solution is discharged from said cavity through the thorough-hole (5) comprised in said microarray (1) and communicating with said cavity.

32. The method according to claim 24, wherein said biomolecule immobilized on the microarray and/or said target biomolecule are labeled with a fluorochrome, and the interaction between said biomolecule on the microarray and said target biomolecule are detected by fluorescence.

33. A method of testing interaction between biomolecules using the device according to claim 14, comprising:
applying an electric field between said microarray (1) and said opposite electrode (2), and
while introducing a solution comprising a target biomolecule and/or a solution not comprising a target biomolecule into said cavity (4), detecting through said opposite electrode interaction between said biomolecule on the microarray and said target biomolecule with a confocal detector.

34. A method of testing interaction between biomolecules using the device according to claim 14, comprising:
applying an electric field between said microarray (1) and said opposite electrode (2),
filling said cavity (4) with a solution comprising a target biomolecule, maintaining the solution in the cavity for a prescribed period, and then discharging said solution, and
detecting through said opposite electrode interaction between said biomolecule on the microarray and said target biomolecule with a confocal detector while said solution is being maintained or after said solution has been discharged.

35. The method according to claim 34, which comprises newly filling said cavity with a solution comprising a target biomolecule and/or a solution not comprising a target biomolecule after said solution has been discharged or while said solution is being discharged.

36. The method according to claim 33, wherein said biomolecule on the microarray and/or said target biomolecule are labeled with a fluorochrome.

37. The method according to claim 33, wherein, with said confocal detector, said protruding spot part on the microarray is detected as a reflected image from the difference in intensity of reflected light based on differences in the height and/or shape of the protruding spot part and other portions on the surface of the microarray.

38. The method according to claim 37, wherein the interaction between biomolecules is detected by detecting fluorescence from said protruding spot part detected as a reflected image.

39. The method according to claim 33, wherein the solution is introduced into said cavity and/or the solution is discharged from said cavity through the through-hole (5) comprised in said microarray (1) and communicating with said cavity.

40. The method according to claim 33, wherein said conductive stuff (7) and said opposite electrode (2) are connected to a terminal of the external power source through the through-hole (8) communicating with said conductive stuff (7) and the through-hole (9) communicating with said opposite electrode (2).

41. The method according to claim 24, wherein the electric field applied between said microarray (1) and said opposite electrode (2) ranges from 0.01 to 10 MV/m.

42. The method according to claim 24, wherein said solution comprising the target biomolecule comprises at least one buffer substance selected from the group consisting of phenylalanine, histidine, carnosine and arginine.

43. A method of measuring a melting temperature of a biomolecule, characterized by using the method according to claim 24.

44. A method of sequencing a nucleic acid, characterized by using the method according to claim 24.

45. A method in which a solution comprising a target biomolecule is placed between a biomolecule microarray comprising one or more spots in which a biomolecule is immobilized on a substrate surface and an electrode facing said substrate surface, which electrode is hereinafter referred to as “opposite electrode”, to cause interaction between said biomolecule immobilized on the substrate surface and said target biomolecule, characterized in that
said microarray comprises a conductive material surface on at least a portion of the surface on which the biomolecule is immobilized, and
a voltage at a frequency ranging from 0.01 to 10 Hz is applied between said conductive material surface and said opposite electrode to promote said interaction.

46. A method of causing migration of a biomolecule comprised in a solution placed between a substrate on at least a portion of which a conductive material surface is comprised and an electrode facing said conductive material surface, which electrode is hereinafter referred to as “opposite electrode”, characterized by applying a voltage at a frequency ranging from 0.01 to 10 Hz between said conductive material surface and said opposite electrode to cause said biomolecule to migrate toward either said substrate or said opposite electrode.

47. The method according to claim 45, wherein said voltage ranges from 0.1 to 4V.

48. The method according to claim 45, wherein said solution comprises a cation.

49. The method according to claim 48, wherein said cation is at least one selected from the group consisting of sodium ion, potassium ion, lithium ion, magnesium ion, calcium ion, and aluminum ion.

50. The method according to claim 48, wherein the concentration of cation in said solution ranges from 1 to 1000 mM.

51. The method according to claim 45, wherein said voltage is a pulsed direct current voltage.

52. The method according to claim 45, further comprising applying the voltage in such a manner that said substrate surface is negatively charged.

53. The method according to claim 45, wherein the whole of said substrate consists of a conductive material or said substrate comprises a conductive material coating layer on the substrate surface.

54. The method according to claim 45, wherein said conductive material is gold, nickel, platinum, silver, titanium, aluminum, stainless steel, copper, chromium, conductive oxide, or conductive plastic.

55. The method according to claim 45, wherein the whole of said opposite electrode consists of gold, nickel, platinum, silver, titanium, aluminum, stainless steel, copper, chromium, conductive oxide, or conductive plastic, or said opposite electrode comprises a conductive material coating layer consisting of gold, nickel, platinum, silver, titanium, aluminum, stainless steel, copper, chromium, conductive oxide, or conductive plastic on the surface thereof facing said conductive material surface of the substrate.

56. The method according to claim 45, wherein said opposite electrode is a transparent electrode.

57. The method according to claim 45, wherein a nonconductive spacer is positioned between said substrate and said opposite electrode, and a space enclosed by said substrate, opposite electrode and nonconductive spacer is filled with said solution.

58. The method according to claim 57, comprising stirring said solution during the period when no voltage is being applied between said conductive material surface and said opposite electrode.

59. The method according to claim 45, wherein said biomolecule is at least one selected from the group consisting of DNA, RNA, PNA, protein, polypeptide, sugar compound, lipid, natural small molecule, and synthetic small molecule.
